(19) United States
(12) Patent Application Publication
(10) Pub. No.: US 2020/0209656 A1
(43) Pub. Date: Jul. 2, 2020

(54) A PHOTONIC DEVICE

(71) Applicant: QUANTUM BASE LIMITED, Stockport, Cheshire (GB)

(72) Inventors: Robert James Young, Lancaster Lancashire (GB); Yasir Jamal Noori, Lancaster Lancashire (GB)

(21) Appl. No.: 16/605,389

(22) PCT Filed: Apr. 18, 2018
(86) PCT No.: PCT/GB2018/051017

§ 371 Date: Oct. 15, 2019

(30) Foreign Application Priority Data
Apr. 19, 2017 (GB) 1706216.7

(51) Int. Cl. G02F 1/035; H01L 33/30; H01L 33/00; H01L 33/04; H01L 31/107; H01L 31/18; H04L 9/08; G06N 10/00

(52) U.S. Cl. CPC G02F 1/0353; H01L 33/30; H01L 33/0012; H01L 33/04; H01L 33/0066; G02F 2202/40; H01L 31/1804; H04L 9/0852; G06N 10/00; G02F 2202/32; H01L 31/107

(57) ABSTRACT

A single-photon light source (2) comprises a photonic crystal structure the lattice of which extends in at least two dimensions and includes a crystal defect defining an optical waveguide (13) for guiding optical radiation emitted within the photonic crystal. An electric field generator (3) is operable to apply an electric field to the photonic crystal. A light emitter selected from: a quantum dot; a quantum well; a light-emitting diode (LED), is arranged within the photonic crystal for responding to the electric field to acquire an excited state and by decaying from the excited state thereby emitting optical radiation into the photonic crystal for guiding by the optical waveguide. The single-photon light source may be used as part of a quantum key distribution transmitter. An integrated single-photon detector (64) is disclosed as part of a quantum key distribution receiver.

### FIELD

The invention relates to photonic devices, and methods for the manufacture of photonic devices. In particular, although not exclusively, the invention relates generally to integrated photonic systems and, more particularly, to integrated photonic systems for quantum cryptography. In addition, although not exclusively, the invention relates to single-photon light sources, detectors and optical components such as phase modulators and waveplates. For example, the invention relates to quantum key distribution (QKD), and photonic devices for use in QKD.

### BACKGROUND

The field of quantum information technology is concerned with, amongst other things, the development of a light source for use in transmitting information in which the number of photons used for such transmissions, can be carefully controlled. The foundations of quantum information technology is the superposition principle of quantum mechanics. This principle tells us that whenever we have two quantum states admissible in a given situation, a linear superposition of the two states is also an admissible quantum state. By applying this principle to an individual quantum particle, such as a single photon, quantum information technology is able to apply the rules of quantum mechanics to the exchange of information using that single quantum particle. This, of course, requires quantum technology to be in a position to generate individual quantum particles, to carry information, reliably and repeatably.

The expansion of telecommunications has raised the need to develop new cryptographic techniques offering high security as well as easy key management. Secrecy requires the distribution of a secret key safely between the emitter and the receiver. An eavesdropper may, of course, intercept a cryptographic key, and copy it. Quantum key distribution, also often referred to as quantum cryptography, prevents this from happening and relies on the superposition principle of quantum mechanics, or entanglement, in order to do so. Quantum key distribution was first proposed in 1984 by Bennett and Brassard, and allows two remote parties to generate a secret random key, used to carry out secure communications, without meeting or resorting to the services of an intermediary/courier. This is based on the fact that, according to quantum mechanics, performing a measurement on an unknown state will in most cases disturb it. This property can be exploited to reveal an eavesdropper. If a sequence of transmitted bits of information, encoded in non-orthogonal states, does not contain any errors, it can be inferred that no eavesdropper has attempted to eavesdrop.

Several examples of quantum key distribution optically, through air, over distances of many kilometres have now been demonstrated in the art. The values of the bits of information distributed in this way, may be encoded into various properties of the photons carrying them. Early in the development of quantum key distribution technology, the properties of photons chosen for encoding information were the phase of the photon and the polarisation state of the photon, or using techniques of energy modulation. It has subsequently been realised that this choice is not optimal. For example, polarisation mode dispersion may become unacceptably large in longer-distance fibre optical links between transmitter and receiver, rendering key distribution impossible. Similarly, the phase of the photons as a choice for carrying bit values faces difficulties. Such a scheme is based on single-photon interference, whereby photons travel successively through interferometers. Their path the differences must be set equal to within less than a wavelength the photon in question, which is very difficult to achieve over large transmission distances. Furthermore, this scheme still requires careful polarisation control in the interferometers in order to be practically effective.

As a result, complex and costly schemes have been developed employing Faraday mirrors and time-multiplexing techniques to improve the reliability of quantum key distribution using photons over longer distances. There exists a need for a simpler and more cost-effective systems for using quantum key distribution routinely and reliably across a wider breadth of circumstances than can realistically be provided using current expensive, bespoke systems, which are ill-suited to cost-effective mass production and every-day use.

### SUMMARY

In a first of its aspects, the present invention may provide single-photon light source comprising: a photonic crystal structure the lattice of which extends in at least two dimensions and includes a crystal defect defining an optical waveguide (and, optionally, also defining an optical cavity) for guiding optical radiation emitted within the photonic crystal; an electric field generator operable to apply an electric field (e.g. in the form of a voltage or potential difference, such as a bias voltage) to the photonic crystal; a light emitter selected from: a quantum dot; a quantum well; a light-emitting diode (LED), within the photonic crystal for responding to the electric field to acquire an excited state and by decaying from the excited state thereby emitting optical radiation into the photonic crystal. The crystal defect defining the optical waveguide may guide the emitted optical radiation in a direction away from the light emitter, through the photonic crystal. In this way, a directed output optical radiation may be provided. The optical radiation may be guided to a desired onward location, which may simply be an output part of the light source (e.g. for outputting the light into free space for transmission away from the light source, optionally to a remote detector or receiver for example), or may be a subsequent optical component. The light emitter is preferably arranged such that the wavelength of a photon emitted by the quantum dot corresponds with an energy (a wavelength) lying within a photonic band gap of the photonic crystal. Consequently, the emitted photon is not able to propagate through the photonic crystal regular structure/array, but is permitted as a light mode of the crystal defects defining the single-mode waveguide.

The parts of the lattice of the photonic crystal defining the optical waveguide may be arranged to impose, induce or preferentially support a predetermined state of linear polarisation in the optical mode(s) of the waveguide. This may be achieved by exploiting the special properties of 2D photonic crystals. Any un-polarized light can be decomposed into two orthogonal components. A first component has its electric field parallel to the plane (TE) of the crystal, and a second component has its magnetic field parallel to that plane (TM). Propagation of the TE and TM polarizations can be decoupled with the result that the TE and TM polarizations have their own band structures and photonic band gaps within the photonic crystal. The transmission of light within the crystal is dependent on its frequency and the photonic band gap band structures of the crystal. Light with frequencies outside a photonic band gap will be able to propagate inside the photonic crystal surrounding the waveguide. However, light with frequencies which lie in the photonic band gap cannot leak into the surrounding periodic media, so that light is guided through the waveguide structure and is often referred to as a defect mode(s). Using techniques readily available to the skilled person, the photonic crustal may be designed so that the defect mode(s) will have only one polarization, as desired. The photon output by such a waveguide may therefore be polarized in a desired state of polarisation. For example, the photonic crystal, and the defect within it defining the waveguide, may be structured such that a TE guided mode exists for this structure in the region where a photonic band gap is observed for TM polarization. Hence, if a photon is input to the waveguide having both TE and TM polarization, then light of TE polarization may be guided in the defect waveguide whereas the light of TM polarization may be blocked because of the photonic band gap. For example, to obtain such an effect the crystal defect defining the waveguide may include one or more (e.g. a relatively short row) of crystal unit cells in which the size/radius of the cell is smaller than elsewhere in the crystal. For example, if the crystal comprises a lattice of dielectric rods (or holes in a dielectric slab), then a cell defect may comprise a rod (hole) of smaller diameter as compared to the rods (holes) in the non-defect parts of the crystal. This row of defects may be followed by a defect comprising an absence of unit cells (e.g. a row absent of dielectric rods, or an absence of holes in a dielectric slab) which define an output waveguide. The waveguide may be arranged such that the structure of the dielectric columns (or holes if in a slab) in the waveguide are employed for use as a polarisation rotator part/section, as discussed below for example, and these structures may be arranged to differ from other columns/holes of the crystal. Such a polarisation rotator part/section may comprise a birefringent material, e.g. such as is discussed below. The refractive index of the birefringent material may be selected to increase the optical volume of the waveguide parts and thus allow multiple modes to be supported. This could be done (if the refractive index is not sufficient, for example) by increasing the size of the confinement region. This may be achieved by shifting the dielectric columns/holes surrounding the waveguide and/or removing multiple rows of columns/holes to create what is known in the art as W2 and W3 waveguides.

The photonic crystal lattice may include a crystal defect defining an optical cavity. The light emitter may be arranged to emit light having a wavelength which renders it a light mode of the crystal defect defining the optical cavity. The light emitter may be disposed within an optical cavity of the photonic crystal which is optically coupled to the optical waveguide. The optical cavity may be separated from the optical waveguide by an intermediate structural element of the photonic crystal lattice, such as one or more unit cells of the photonic crystal, or a part thereof. For example, if the photonic crystal comprises a lattice of dielectric rods, then each unit cell may comprise dielectric rods, and the intermediate structural element in question may be one or more dielectric rods (e.g. forming a short row). For example, if the photonic crystal comprises a lattice of holes in a dielectric slab, then each unit cell may comprise holes, and the structural element in question may be one or more such holes (e.g. forming a short row). It is to be noted that this intermediate structural element may serve the purpose of a row of defects designed to promote/induce a predetermined state of linear polarisation in the optical modes of the waveguide, as discussed above.

The photonic crystal may comprise a triangular lattice, or a square lattice. This means that the unit cell geometry comprises a triangular (or square) arrangement of rods or holes, which repeat periodically to define the crystal lattice. Other geometries are possible. The photonic crystal may comprise a lattice of dielectric rods, or may comprise a dielectric slab comprising an array of holes. Rods of the photonic crystal (e.g. all rods), where rods are used, may be circular cylindrical dielectric columns. Where holes in a slab are used, the holes may be circular cylindrical holes. Other shapes may be used. Spaces between columns, or within holes, may contain (e.g. be filled with) suitable optically transparent material (e.g. as discussed below).

The photonic crystal preferably comprises a layered structure having three distinct layers of semiconductor material forming a p-i-n semiconductor switch arrangement. For example, where the photonic crystal comprises dielectric columns, a base column portion of some or each dielectric column is formed from an n-doped semiconductor material, upon which may be formed a mid-column portion which is formed from an intrinsic semiconductor material or from a relatively very lightly doped semiconductor material, and a top column portion may be formed on top of the mid-column portion thereby to sandwich the mid-column portion between the base and top colour portions. The top column portion may be formed from a p-doped semiconductor material. A quantum dot structure (or quantum well, or LED) may be formed/embedded within the intrinsic semiconductor material of the mid-column portion. Alternatively, this layered structure may be present in the dielectric slab structure of the photonic crystal when a dielectric slab-with-holes is used. This layering structure especially lends itself to simple, cheap and effective manufacturing processes involving e.g. epitaxy or other well-used layer-growth processes common in the electronics/semiconductor manufacturing art. The photonic crystal is preferably formed upon, and extends perpendicularly from a surface of a substrate which may be a silicon (Si) or germanium (Ge) substrate.

The electric field generator is preferably arranged to conduct an electrical current through the/a embedded quantum dot (or well/LED), e.g. such as described above, when the electric field is applied thereby. Electrical drive contact electrodes may be formed upon and/or adjacent to the photonic crystal and/or the substrate in proximity to the quantum dot (or well/LED) to allow the electric field and current to flow through the quantum dot (well/LED) embedded within the p-i-n semiconductor structure. The quantum dot (well/LED) may be embedded within a dielectric column of the photonic crystal. The dielectric column may define a crystal defect so as to form an optical cavity therein. It may be centred within the optical cavity. A first electrical drive contact electrode may be formed in electrical communication with the terminal top end of the dielectric column defect. A second electrical drive contact electrode may be formed in electrical communication with the substrate at a location adjacent the optical cavity of the photonic crystal. The first electrical drive contact electrode is preferably structured and arranged to form an electrical contact with only to the defect dielectric column within the optical cavity. This ensures that a path of current flowing between the two electrical drive electrodes passes only through the defect dielectric column, and does not pass through any of the other dielectric columns of the crystal. Other dielectric columns of the crystal may also contain quantum dots (wells/LEDs), as a result of the layered manufacturing process, and preferably the drive electrodes only provide current flow through the quantum dot (well/LED) located within the optical cavity, and that they do not provide current to any of the other quantum dots (wells/LEDs) within other dielectric columns.

Both the first and the second drive electrode are preferably in electrical communication with the electronic control unit which, collectively form the electric field generator. The electronic control unit may form a part of a quantum key distribution (QKD) transmitter system. In this way, the electronic control unit may be arranged to control the generation of single photons for use in QKD.

The quantum dot (or well/LED) may be composed of different types of semiconductor materials such as is readily available to the skilled person. Examples include: In(Ga)As for a quantum dot, or a quantum well in GaAs, with e.g. an Al(Ga)As barrier material. Other options include InAs/GaAs, or InP/GaInP.

The magnitude of the pumping current for the quantum dot (well/LED), and the repetition rate/frequency at which one may preferably apply the pumping current pulses, may be optimised. The quantum dot may provide electrically pumped single-photon emission at speeds of up to several hundred MHz. The voltage applied to the quantum dot (well/LED) is preferably above the quantum confined exciton's energy in the dot/well (resonant excitation), or optionally above the bandgap of the bulk semiconductor (non-resonant) of the structure. In preferred embodiments, the voltage may be between about 0.7 and about 2V, such as about 1.5V. The repetition rate of the voltage pulses may preferably be between about 1 MHz and a few GHz (e.g. 1 GHz, or 2 GHz, or 3 GHz). Fast switching of the p-i-n junction allows quantum dot (well/LED) pumping to occur over a short time interval.

In preferred embodiments, the p-i-n junction may be driven with drive voltage pulses of small amplitude (quick switching) superimposed upon a DC voltage bias set to just below the p-i-n switching threshold voltage. In preferred embodiments, the amplitude of the drive voltage pulses may be substantially the smallest possible amplitude (or a few percent, or less than about 10%, above that smallest amplitude) of AC drive pulse needed to induce emission. This way the device can be operated more quickly by relying on very small voltage changes to pump the emitter.

Preferably, the optical cavity/emitter is arranged to operate in the weak coupling regime. The cavity is desirably designed such that the quality factor, Q, is preferably low, preferably being in the range: about 1<Q<about 10000; or about 1<Q<about 5000; or about 1<Q<about 1000; or about 1<Q<about 500; or about 1<Q<about 400; or about 1<Q<about 300; or about 1<Q<about 200. The value of a cavity decay rate of the optical cavity may be between about 50 μeV and 500 μeV, such as between about 100 μeV, or about 300 μeV. The cavity lifetime may be in the range of about 0.5 picosecond to about 10 picosecond, typically being of the order of a picosecond. The decay rate of a quantum dot may be of the order of several μeV, such as between about 1 μeV and about 10 μeV, The radiative life of the exciton within the quantum dot may be between about 50 ps and about 5 ns. The time duration (Tₚᵤₗₛₑ) of voltage drive pulses used to drive the quantum dot (well/LED) is preferably such that: Tₚᵤₗₛₑ<1/F, where F is the decay rate of the quantum dot (well/LED) from an excited state to its ground state.

The drive pulse(s) may be of substantially static amplitude (e.g. rectangular pulses). This condition ensures that the emitter is very rapidly pumped to an excited state and, long before it is expected to have decayed, the emitter is left unperturbed by the drive voltage signal to allow the emitter to decay to a ground state during the subsequent interval time period (Tᵢₙₜ) before a/any subsequent drive voltage pulse is applied. In this way, the invention ensures a high probability that the quantum dot is not pumped twice (or more) by the same single pumping/drive pulse thereby avoiding the likelihood of the quantum dot emitting more than one photon into the optical cavity in response to a single pumping/drive pulse. The time interval (Tᵢₙₜ), between drive voltage pulses may be selected to be sufficiently large that there is a high probability that the quantum dot has decayed from its excited state to a lower state, and has emitted a single-photon into the optical cavity within that time interval, and before a subsequent drive/pumping pulse is applied to the quantum dot by the electric field generator.

Accordingly, the time interval Tₚᵤₗₛₑ may be such that: Tᵢₙₜ>1/Γ. The radiative life of the exciton within the quantum dot may be between about 50 ps and about 5 ns. The exciton lifetime in the quantum dot may be of the order of a nanosecond, such as about 0.5 ns to about 10 ns. This means that once the exciton has decayed and emitted a photon into the cavity, the cavity then very quickly emits the photon. The cavity linewidth preferably is large, and may be in the range: about 10 meV<Δλ_{c}<about 100 meV; or about 10 meV<Δλ_{c}<about 80 meV; or about 10 meV<Δλ_{c}<about 60 meV; or about 10 meV<Δλ_{c}<about 40 meV; or about 10 meV<Δλ_{c}<about 30 meV. As a result of the breadth, the emission wavelength of the quantum dot (well/LED) need not be precisely close to the centre wavelength of the cavity linewidth, yet will remain effective. The presence of only a single dielectric column (or hole in a dielectric slab of the photonic crystal, or just a few columns (holes) (e.g. a row of two, three or thereabouts) separating the optical cavity and the waveguide of the photonic crystal, renders the optical cavity deliberately “leaky”.

The photonic crystal may be formed from one or more group III-V semiconductor materials and may be formed upon a group IV semiconductor material, such as being formed in a layer grown upon a group IV semiconductor material. The photonic crystal may be formed from one or more direct-gap semiconductor materials and may be formed upon an indirect-gap semiconductor material. The direct-gap semiconductor material may be a group III-V semiconductor material, and the indirect-gap semiconductor material may be a group IV semiconductor material.

The single-photon light source may include a polarisation rotator arranged to adjustably change the state of polarisation of a photon generated by the light emitter. The polarisation rotator may be arranged in optical communication with the light emitter so as to receive photons emitted thereby. The polarisation rotator may comprise (e.g. effectively act as) a waveplate. The single-photon light source may include a phase adjuster arranged to adjustably change the phase of a photon generated by the light emitter. The polarisation rotator (waveplate or phase-modulator), may comprise an optical waveguide containing a field-induced birefringence material within the optical guiding pathway of the waveguide. The optical waveguide may be formed by the linear photonic crystal defect, and within light-guiding parts of the waveguide may be disposed the field-induced birefringence material. This may be any suitable optically transmissive material responsive to an applied electric field to adopt birefringence.

Such materials are readily available to the skilled person. Application of an electrical field of suitable magnitude has the effect of causing the material to acquire and “optic axis” so that birefringence occurs for optical propagation perpendicular to the axis. This imposes a phase difference as between those components (as projected/resolved onto the optical axes of the birefringence material) of the electrical filed vibrations of a propagating linearly polarised photon, given by:

Δϕ=2πΔntf/c

Where, Δn is the difference between refractive indices (‘ordinary/extraordinary’ or ‘slow/fast’); t is the length of the waveguide containing the birefringence material; f is the frequency of light, and c its speed in vacuum. The amount of phase shift may be controlled not only by Δn but also by an appropriate value of t, the length of the waveguide containing the material. The field strength applied to the birefringence material is preferably selected, for a given value of t, to achieve the necessary change Δn in refractive index within the waveguide to achieve a desired phase difference Δϕ at the output of the waveguide, and thus, at the output of the waveplate/phase shifter. In this way, a phase difference as between those components (as projected/resolved onto the optical axes of the birefringence material) of the electrical filed vibrations of the output photon, changes the state of polarisation of the photon. The single-photon light source may include an electronic control unit arranged to apply an electric field across the field-induced birefringence material, to induce a predetermined birefringence thereto. This allows a predetermined phase difference Δϕ to be introduced between the polarisation components (i.e. those resolved onto the fast ad slow axes) of a photon output from the light emitter to rotate the initial linear state of polarisation of the photon to any linear or circular polarisation state required. The photonic crystal defining the waveguide of the polarisation rotator containing the birefringent material, is preferably arranged to be un-polarising, and not sympathetic to any one linear polarisation state over any another. Birefringence control electrodes may be arranged on the polarisation rotator. They may be disposed at locations which place those electrodes at opposite sides of the photonic crystal defining the optical waveguide of the polarisation rotator. Thus, the electric field generated between them may extend transversely across the linear axis of the waveguide containing the field-induced bi-refringent material. Alternatively, one birefringence control electrode may be arranged to extend along the optical waveguide directly above the linear defect in the photonic crystal defining that waveguide. Another birefringence control electrode may be arranged upon a surface of the substrate at one side of the photonic crystal extending along an outermost row of the crystal lattice in parallel to the linear axis of the single mode waveguide.

Thus, the polarisation rotator may comprise (e.g. effectively act in the manner or) a waveplate (or phase modulator) as described above. In general, in a second of its aspects, the invention may provide waveplate (or phase modulator) comprising: a photonic crystal structure the lattice of which extends in at least two dimensions and includes a crystal defect defining an optical waveguide for guiding optical radiation within the photonic crystal; an electric field generator operable to apply an electric field to the photonic crystal; a field-induced birefringence material disposed within the crystal defect for reversibly responding to said electric field to acquire an optical birefringence thereby to impose a phase shift upon optical radiation guided by the optical waveguide.

The photonic crystal may comprise a periodic lattice of dielectric columns, or of holes formed in a dielectric slab or sheet. The lattice may be arranged as a triangular lattice symmetry, or may be or square lattice symmetry. Other lattice symmetries are possible. When the lattice comprises dielectric columns, they may be circular cylindrical dielectric columns, or where the lattice comprises holes formed in a dielectric slab/sheet, the holes may be circular holes.

The photonic crystal may be formed from one or more group III-V (e.g. direct-gap) semiconductor materials and may be formed upon a group IV (e.g. indirect-gap) semiconductor material. The direct-gap semiconductor material may be a group III-V semiconductor material, and the indirect-gap semiconductor material may be a group IV semiconductor material.

The electric field generator may be arranged to apply an electrical field to the field-induced birefringence material to adjustably change the state of polarisation of a photon within the crystal defect selectively to any one of a plurality of different states of polarisation.

The electric field generator may be arranged to apply an electrical field to the field-induced birefringence material via electrical contacts arranged at opposites sides of the photonic crystal lattice, or via electrical contacts of which one is arranged across the plane of the photonic crystal lattice adjacent, or over, the linear defect defining the waveguide.

In a third of its aspects, the invention may provide a method for manufacturing a photonic crystal integrated chip comprising: epitaxially growing a first substrate comprising a group IV single crystal semiconductor material; epitaxially growing a second substrate directly upon the first substrate, in which the second substrate comprises a group III-V single crystal semiconductor material; etching the second substrate to form a 2-dimensional photonic crystal structure. The method enables the manufacture of a photonic crystal integrated chip. A first step may comprise epitaxially growing a silicon (Si) layer. The second step may comprise epitaxially growing a second layer of GaAs directly upon the Si substrate. Molecular beam epitaxy, or chemical vapour deposition, may be used to deposit successive substrates and layers of the layered structure. In preferred embodiments, a silicon (or germanium) substrate may initially have grown upon it a type III-V buffer layer (e.g. AlAs, or a GaAs/Al(Ga)As super lattice) which may have minimal thickness of between about 5 nm and about 50 nm, for example. The second substrate may be grown upon the buffer layer. In a fourth of its aspects, the invention may provide a photonic crystal integrated chip comprising a two-dimensional photonic crystal structure formed from a material grown upon a substrate (e.g. a first substrate), wherein the photonic crystal structure comprises a group III-V (e.g. direct-gap) single crystal semiconductor material (e.g. a second substrate) and the (first) substrate comprises a group IV (e.g. an indirect-gap) single crystal semiconductor material thereby collectively defining an integrated photonic chip.

The second substrate may be grown as a layered structure itself. The second substrate may comprise a first sub-layer of n-doped semiconductor material (e.g. GaAs), which is grown directly upon the surface of the first substrate, followed by an un-doped second sub-layer of intrinsic semiconductor material (e.g. GaAs) grown upon the surface of the first sub-layer. During the growth of the second sub-layer, the process of growth of the intrinsic material may be interrupted, and temporarily replaced by a process of growth of at least one, and preferably a plurality, of quantum dots (or quantum wells/LEDs) upon the exposed surface of the intrinsic semiconductor material. A suitable procedure of growing the quantum dots would be any one of the following: the well-known Stranski-Kranstanov procedure; the well-known Droplet Epitaxy procedure; Other suitable procedure as would be readily apparent to the skilled person. The different component semiconductor arrangements suitable for the quantum dot, are as described above.

Once sufficient quantum dots (or quantum wells/LEDs) are provided, per unit area of the exposed surface, the process of growth of the intrinsic semiconductor material may be resumed thereby to bury/embed/encase the quantum dots (or quantum wells/LEDs) within the intrinsic semiconductor material, and complete the formation of the second sub-layer. A third sub-layer of p-doped semiconductor material may be grown directly upon the surface of the completed second sub-layer.

The process of manufacture of a photonic crystal chip may continue with a third step in which the epitaxially grown, layered semiconductor structure provided by the preceding process steps is etched to form a photonic crystal structure. The photonic crystal structure may be etched to include a linear crystal defect defining an optical waveguide. The photonic crystal structure may be etched to include a defect, preferably comprising a point defect, containing a quantum dot (or well, or LED) optically coupled to the waveguide e.g. when a single-photon source is being manufactured, within the photonic crystal structure. The photonic crystal structure may be etched to include a defect defining an optical cavity containing the quantum dot (or well, or LED). In particular, the process of etching is preferably implemented upon the second layer consisting of the three sub-layers described above. In preferred embodiments, the etching process may be selected and arranged to define a triangular lattice of upright, linear circular cylindrical dielectric rods. Alternatively, the photonic crystal may be etched as a lattice of holes within the slab formed by the second substrate. Lattice geometries other than triangular, and rods/holes other than circular cylindrical may be formed.

The same process may also be employed to manufacture photonic crystal chips defining optical waveguides used in polarisers and polarisation rotators (waveplates, or phase modulators) which have been described above, in any aspect. The etching process may define/form a photon out-coupler and/or a photon in-coupler (e.g. a Bragg mirror, or wedge) as described herein in any aspect of embodiment. A dry etching method, such as reactive-ion etching, may be employed to etch structures (e.g. photonic crystal structures; Bragg mirrors etc.) into the layers of the layered structure formed by the preceding growth steps, described above. The dielectric columns of the photonic crystals may be other than circular cylindrical. Other, different cylindrical geometries for the columns would be acceptable. However, square cylinders, or other cylinder shapes, are more difficult to manufacture/process, and it has been found that cylinders of a circular cross-section is the easiest shape to manufacture reliably with sufficient quality.

Desired materials may be deposited within the empty portions or gaps formed by the etching process, such as optically transparent material within the photonic crystal structure or Bragg grating/mirror structures, or field-induced birefringence material or field-induced variable index (refractive index) material within optical waveguide structures. Overlaying structures may then be deposited upon the etched, and optionally filled, structures formed in the layered structure, so as to provide optical confinement functions, and/or to provide electrical contacts. For example, metallic contacts (e.g. gold) may be deposited as strips, plates or layers along the side and/or upon or over desired parts of the etched and layered structure. Examples include: electrical contact plates adjacent a photonic crystal lattice for supporting an electrical field in a polarisation rotator, such as described above; and/or electrical contacts upon and adjacent a photonic crystal lattice for supporting an electrical drive current through a quantum dot located in an optical cavity of a single-photon source, such as described above; and/or electrical contacts for supporting a bias voltage to be applied across a p-i-n structure of an avalanche photodiode, such as described herein.

The first and second growth stages may be performed as successive parts of a continuous growth process.

The group III-V semiconductor material may be a direct-gap material and the group IV semiconductor material may be an indirect-gap material.

The photonic crystal structure may include a lattice defect defining an optical waveguide therein. The first substrate may comprise an avalanche photodiode (APD) semiconductor structure. The APD may be a silicon-based APD. A waveguide structure may be etched in the second substrate on top of that. The APD structure may three layers comprising a p-i-n photodiode structure, in which the intrinsic region is engineered to provide the avalanche event.

Accordingly, in a fifth of its aspects, the invention may provide a photo-detector integrated chip comprising an optical waveguide structure formed in one or more layers grown upon a substrate and an optical out-coupler coupled to an optical waveguide structure to re-direct guided light from the optical waveguide structure into the substrate, wherein the substrate comprises semiconductor layers of an avalanche photodiode, thereby collectively defining an integrated photo-detector chip.

An optical in-coupler and/or an optical out-coupler employed in preferred embodiments of the invention, and may comprise a sequence of in-plane perturbations in a dielectric material disposed in-plane with the transmission axis of an optical waveguide, for receiving/inputting photons from/into or towards the optical waveguide. The optical in-coupler or out-coupler may incorporate integrated grating structures comprising periodic perturbations in the dielectric material of the coupler with a period that matches the optical mode of the optical waveguide it serves. This type of structure may be used to out-couple (or in-couple) light from (or to) a single photon light source described above in any aspect, or from a polarisation rotator (waveplate, or phase modulator) described above in any aspect, or an avalanche photodiode of a photo-detector integrated chip described above in any aspect of the invention. For example, and in order to illustrate some of the possible arrangements described above, the optical out-coupler may be arranged to output directly into free-space the light it received from the single-photon light source, for free-space transmission. For example, and in order to illustrate some of the possible arrangements described above, the optical in-coupler may be arranged to receive (as an input) light directly from free-space (e.g. as transmitted by a/the single-photon source) to couple that light to the photo-detector.

The dielectric perturbations within the coupler may be arcuate and concentric each with a radius of curvature converging within or upon the optical waveguide in question. The radius of curvature of successive arcuate perturbations may increase in succession such that neighbouring perturbations remain mutually parallel. In preferred embodiments, the concentric dielectric perturbations may be substantially semi-circular with a shared radius of curvature, which may converge upon the optical output end e.g. port, of the optical waveguide served by the optical in-/out-coupler. The periodic dielectric perturbations forming the in-/out-coupler may comprise consecutive ridges of optically transmissive higher refractive index material (e.g. SiO₂) separated by spacings containing lower refractive index material (e.g. air, or other lower-index optically transmissive material).

The in-/out-coupler may comprise a planar slab or sheet of optically transmissive dielectric material (e.g. a glass, e.g. SiO₂) with the periodic dielectric perturbations each arranged to extend in length within the plane of the slab, and in depth transversely to the plane of the slab. The periodic perturbations may extend to/from an edge of the planar slab or sheet so as to be optically visible or present at that edge, rendering the in-/out-coupler able to attain an optical coupling immediately at that age. The radii of curvature of curved periodic perturbations may each converge upon the edge in question. There may be no more than two periodic perturbations in the dielectric material of the slab. These may comprise two concentric, curved grooves or slots or gaps empty of the dielectric material of the slab (but optionally containing lower index optically transparent material). The groups, slots, gaps or spacings may be each of the same constant width and may be of the same constant depth. In particular, such a structure may provide a Bragg mirror in/out-coupler.

The avalanche photodiode structure is integrated with the optical waveguide, and may be optically coupled to it via a planar reflective surface, or mirror optical out-coupler or a diffractive out-coupler (e.g. Bragg mirror) as described above. The optical out-coupler of the photodetector integrated chip, may direct light in a direction transverse to the plane of the avalanche photodiode structure and towards it, for detection thereby. The optical out-coupler may comprise an oblique reflective interface (e.g. planar) formed by/at a high contrast in refractive index disposed across the transmission axis of the waveguide. The refractive index of the material of the oblique planar layer may be suitably significantly higher than, or alternatively may be suitably significantly lower than, the refractive index of the material forming the optical waveguide. Both situations will provide an interface with high refractive index contrast which, consequently, will be reflective.

In a sixth of its aspects, the invention may provide a method for manufacturing a photo-detector integrated chip comprising: epitaxially growing a substrate forming semiconductor layers of an avalanche photodiode; epitaxially growing one or more layers directly upon the substrate; forming within the one or more layers an optical waveguide structure and forming an optical out-coupler on the substrate optically coupled to the optical waveguide to re-direct guided light from the optical waveguide structure into the substrate towards the avalanche photodiode therein. The method may be included in a method of manufacturing a quantum key distribution receiver photonic chip within which the photo-detector is arranged to detect photons conveying a cryptographic key.

The method may include forming a photonic crystal in the one or more layers in which the optical waveguide is formed within a photonic crystal. In the method, the optical out-coupler may be formed with a reflective surface disposed obliquely at an end of the optical waveguide. In the method, the optical out-coupler may be formed as a diffraction grating structure.

In a further aspect, the invention may provide a quantum key distribution transmitter apparatus for transmitting single photons conveying a quantum cryptographic key, and/or a quantum key distribution receiver apparatus for receiving single photons conveying a quantum cryptographic key, comprising a single-photon source as described above, and/or comprising a waveplate as described above, and/or comprising a photonic crystal integrated chip as described above, and/or comprising a photo-detector integrated chip as described above.

For example, the invention may provide a quantum key distribution transmitter apparatus comprising a single-photon light source as described above in any aspect. The apparatus may also include a photonic crystal polarising waveguide structure (such as described above) optically coupled to the single photon light source for receiving photons output thereby and for outputting such photons in a predetermined state of linear polarisation imposed by the waveguide. The apparatus may also include a polarisation rotator (or waveplate, or phase modulator) as described above in any aspect, which is optically coupled to the single-photon light source and/or the polarising waveguide structure for receiving photons output thereby and for outputting such photons in a predetermined state of linear polarisation imposed by the polarisation rotator. The apparatus may include an optical out-coupler, such as is described in any aspect above, which is optically coupled to the single-photon light source and/or the polarising waveguide structure or polarisation rotator to out-couple photons output thereby, for onward transmission (e.g. via an optical transmission structure/line, or via free-space) to a quantum key distribution receiver apparatus. Any one of the following parts: the single-photon source; the polarising structure; and the polarisation rotator, may include one or each of an optical in/out-coupler as described above in any aspect, to place that part in optical communication with the other part with which is it optically coupled. Alternatively, two or all of the parts may preferably be integrally formed as one integrated photonic chip via continuous or integrally coupled optical structures (e.g. photonic crystal structures etc.)

For example, the invention may provide a quantum key distribution receiver apparatus comprising a single-photon light detector (photo detector) as described above in any aspect. The apparatus may also include a polarisation rotator (or waveplate, or phase modulator) as described above in any aspect, for receiving transmitted photons carrying a quantum cryptographic key, and for imposing a predetermined polarisation state upon the received photon, for transmission to the single-photon detector. The apparatus may comprise photonic crystal polarising waveguide structure which is optically coupled to the polarisation rotator for receiving photons output by it and for outputting such photons in a predetermined state of linear polarisation imposed by the polarising waveguide structure, for onward transmission to the single-photon detector. The apparatus may include an optical in-coupler, such as is described in any aspect above, which is optically coupled to the polarisation rotator to in-couple incoming to it photons transmitted by a quantum key distribution transmitter apparatus (e.g. via an optical transmission structure/line, or via free-space). Any one of the following parts: the single-photon detector; the polarising structure; and the polarisation rotator, may include one or each of an optical in/out-coupler as described above in any aspect, to place that part in optical communication with the other part with which is it optically coupled. Alternatively, two or all of the parts may preferably be integrally formed as one integrated photonic chip via continuous or integrally coupled optical structures (e.g. photonic crystal structures etc.)

The polarisation rotator (waveplate, or phase modulator) employed in either one of, or both of, the quantum key distribution receiver/transmitter apparatus may employ a field-induced birefringence optical material responsive to an applied electrical field to adopt one of a predetermined number of states of birefringence selected randomly. Either one of, or both of, the quantum key distribution receiver/transmitter apparatus may employ a random number generator, preferably a non-deterministic random number generator (such as a quantum random number generator), to apply a randomly selected one of a discrete number (e.g. four) of predetermined electrical field values/strengths to the birefringence material thereby to randomly select states of birefringence selected therein from a predetermined discrete number of possibilities. Either one of, or both of, the quantum key distribution receiver/transmitter apparatus may randomly select optical bases of a cryptographic key accordingly, e.g. according to a BB84 protocol, or other protocol as desired.

Either one of, or both of, the quantum key distribution receiver/transmitter apparatus may be arranged to electrically control the single-photon light source (single-photon light detector) to emit (detect) a single photon at, or during, intervals of time which are synchronised with the time intervals during which the respective random number generator is operated to apply said randomly selected electrical field values/strengths to the birefringence material of the respective polarisation rotator (waveplate or phase modulator).

A suitable example of a field-induced birefringence material, for use as described above in any aspect, may be a liquid crystal material, or a polymer-stabilized liquid crystal composite, such as is readily apparent and available to the skilled person. Many other suitable field-induced birefringence materials are available and may be suitable.

The term ‘about’ when used in this specification refers to a tolerance of +10%, of the stated value, i.e. about 50% encompasses any value in the range 45% to 55%, In further embodiments ‘about’ refers to a tolerance of +5%, +2%, +1%, +0.5%, +0.2% or 0.1% of the stated value.

### BRIEF DESCRIPTION OF DRAWINGS

There now follow illustrations of preferred embodiments of the invention, by way of example only, with reference to the following drawings:

FIG. 1 schematically illustrates a quantum key optical transmitter system;

FIG. 2 schematically illustrates, in cross-sectional plan view, a single-photon source employed in the transmitter system of FIG. 1, employing a photonic crystal incorporating an optical cavity and a single-mode waveguide within its crystal structure. The photonic crystal extends in a 2D plane (containing the notional x and y spatial axes) and dielectric columns extend perpendicular to that (parallel to the notional z-axis);

FIG. 3 schematically illustrates a cross-sectional side-view of the single-photon source of FIG. 2 taken in cross-section along the axis of the single-mode waveguide and optical cavity of the photonic crystal in a plane containing the notional x and z spatial axes;

FIG. 4 schematically illustrates a cross-sectional view of the single-photon source of FIG. 2 taken in cross-section transverse to the cross-section of FIG. 3, and passing through the centre of the optical cavity of the photonic crystal in a plane containing the notional y and z spatial axes;

FIG. 5 schematically illustrates, in cross-sectional plan view, a polarisation rotator employed in the transmitter system of FIG. 1, employing a photonic crystal incorporating a single-mode waveguide within its crystal structure. The photonic crystal extends in a 2D plane (containing the notional x and y spatial axes) and dielectric columns extend perpendicular to that (parallel to the notional z-axis);

FIG. 6 schematically illustrates a cross-sectional side-view of an alternative embodiment of the polarisation rotator employed in the transmitter system of FIG. 1, employing a photonic crystal incorporating a single-mode waveguide within its crystal structure, in a plane containing the notional x and z spatial axes. This alternative polarisation rotator employs an electric field applied in the z-direction by fabricating an contact above the birefringent material, rather than adjacent to it as in the system of FIG. 5;

FIG. 7 schematically illustrates a cross-sectional plan view of the photon out-coupler of the transmitter system of FIG. 1, employing a photonic crystal incorporating a single-mode waveguide within its crystal structure. The photonic crystal extends in a 2D plane (containing the notional x and y spatial axes) and dielectric columns extend perpendicular to that (parallel to the notional z-axis);

FIG. 8 schematically illustrates a cross-sectional plan view of an alternative embodiment of the photon out-coupler employed in the transmitter of FIG. 1, employing a photonic crystal incorporating a single-mode waveguide within its crystal structure. The photonic crystal extends in a 2D plane (containing the notional x and y spatial axes) and dielectric columns extend perpendicular to that (parallel to the notional z-axis);

FIG. 9 illustrates elements of an arrangement of a transmitter system of FIG. 1 comprising the single-photon source, polariser, polarisation rotator, and photon out-coupler integrated as a single unit, in which the polarisation rotator integrated into one photonic crystal structure which also comprises the polariser and the single-photon source;

FIG. 10 illustrates elements of an arrangement of a transmitter system of FIG. 1 comprising the single-photon source, polariser, polarisation rotator, and photon out-coupler, integrated as a single unit, in which one photonic crystal structure integrates the single-photon source and the polariser, whereas the polarisation rotator is provided via field-induced birefringence materials not forming part of the photonic crystal;

FIG. 11 schematically illustrates a quantum key optical receiver system;

FIG. 12 schematically illustrates a cross-sectional plan view of a photon in-coupler of the receiver system of FIG. 11, employing a photonic crystal incorporating a single-mode waveguide within its crystal structure. The photonic crystal extends in a 2D plane (containing the notional x and y spatial axes) and dielectric columns extend perpendicular to that (parallel to the notional z-axis);

FIG. 13 schematically illustrates a cross-sectional plan view of an alternative embodiment of the photon in-coupler employed in the receiver of FIG. 11, employing a photonic crystal incorporating a single-mode waveguide within its crystal structure. The photonic crystal extends in a 2D plane (containing the notional x and y spatial axes) and dielectric columns extend perpendicular to that (parallel to the notional z-axis);

FIG. 14 schematically illustrates a side, cross-sectional view of a single-photon detector of the receiver system of FIG. 11, in an embodiment in which a single-photon detector is optically coupled to the output of the polariser of the optical receiver system, via an optical out-coupler;

FIG. 15 schematically illustrates a side, cross-sectional view of a single-photon detector of the receiver system of FIG. 11, including a structurally-integrated single-photon detector;

FIG. 16 illustrates an alternative embodiment of the elements of a single-photon optical transmitter, employing a photonic crystal, in which photonic crystal structure illustrated in FIG. 9 comprising pillars, is instead provided by a photonic crystal structure comprising a slab containing a lattice structure of holes collectively defining an optical cavity and a waveguide to a Bragg mirror out-coupler;

FIG. 17 shows a magnified view of the output end of the photonic crystal waveguide of FIG. 16, and the Bragg mirror out-coupler at that end;

FIG. 18A illustrates a flow-diagram of steps in a sequence of manufacturing a single-photon light source within a photonic crystal by a process of epitaxy;

FIG. 18B illustrates a flow-diagram of steps in a sequence of manufacturing a single-photon detector by a process of epitaxy;

FIG. 19 schematically illustrates the process of electrically pumping a quantum dot, or quantum well, located within the intrinsic semiconductor region of a p-i-n semiconductor forming a photonic crystal pillar centred in the optical cavity of the photonic crystal schematically illustrated in FIGS. 1 to 3;

FIG. 20 schematically illustrates, in more detail, the electrical timing and magnitude of electrical signals applied to the p-i-n semiconductor pillar within the optical cavity of the photonic crystal of FIGS. 1 to 3, and their relationship to the optical coupling between the quantum dot within that pillar and the optical cavity within which the pillar resides;

FIG. 21 schematically illustrates a quantum key optical transmitter system in which single-photons are encoded by phase modulation of the photon;

FIG. 22 schematically illustrates a quantum key optical receiver system for receiving photons encoded by phase modulation;

FIG. 23 schematically illustrates an alternative embodiment of a quantum key optical receiver system;

FIG. 24 illustrates an example of an integrated slab optical waveguide for a quantum key distribution receiver system, in which an avalanche photodiode structure is integrated with the slab optical waveguide, and optically coupled to it via a planar mirror optical out-coupler;

FIG. 25 illustrates an example of an integrated slab optical waveguide for a quantum key distribution receiver system, in which an avalanche photodiode structure separate from the slab optical waveguide, and optically coupled to it via a beam optical out-coupler;

FIG. 26 illustrates an example of an integrated slab optical waveguide for a quantum key distribution receiver system, in which an avalanche photodiode structure is integrated with the slab optical waveguide, and optically coupled to it via a Bragg mirror optical out-coupler.

### DESCRIPTION OF EMBODIMENTS

In the following, like items are referred to by like reference symbols, for consistency.

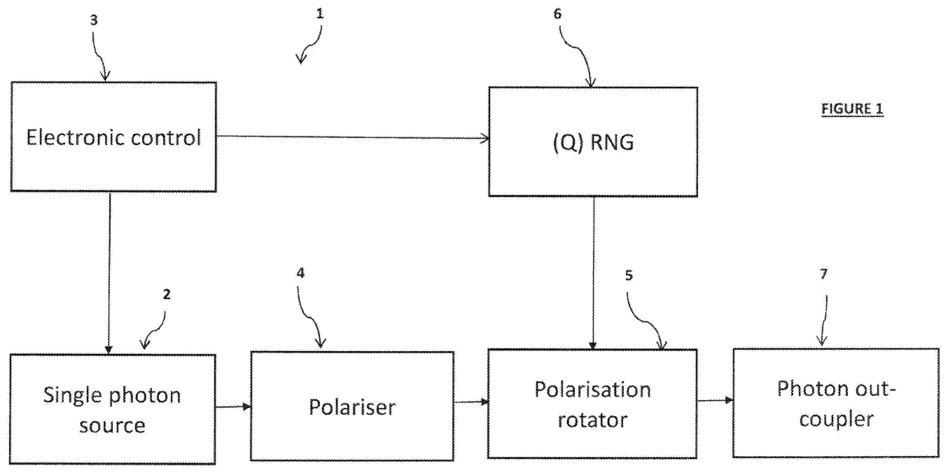

FIG. 1 schematically illustrates a quantum key distribution transmitter system 1 for use in generating and transmitting a cryptographic key. The transmitter comprises a single-photon source 2 arranged to generate and emit single photons controllably, one photon at a time, in response to electrical control signals generated by an electronic control unit 3 arranged in command communication with the single-photon source. The single-photon source is connected in optical communication with an optical polariser 4 arranged to receive at an optical input part (e.g. input port) thereof individual photons output by an optical output part (e.g. output port) of the single-photon source. The optical polariser is arranged to impose a predetermined state of linear polarisation upon photons received from the single-photon source, and to direct linearly polarised photons to an optical output part (e.g. output port) of the polariser for onward transmission to a polarisation rotator 5 arranged to impose a pre-selected rotation to the plane of linear polarisation of individual photons received thereby. Accordingly, the optical output part (e.g. output port) of the polariser 4 is arranged in optical communication with an optical input part (e.g. input port) of the polarisation rotator 5, for receiving individual photons to which polarisation rotation is to be applied. Polarisation-rotated individual photons are subsequently directed to an optical output part (e.g. output port) of the polarisation rotator which is, itself, arranged in optical communication with the input part (e.g. input port) of a photon out-coupler 7. The photon out-coupler is arranged to couple the polarisation-rotated individual photon out from the quantum key distribution transmitter 1, for onward transmission. This onward transmission may be conducted via any suitable optical transmission medium or mechanism, such as a fibre-optic medium, or may be free-space transmission.

References herein to optical “input parts” and optical “output parts” may be understood to encompass arrangements in which such parts are individual structures of a component part or unit of the apparatus, and also to encompass arrangements in which such parts are integrally formed within a structure or unit of the apparatus such that, for example the output part of a proceeding unit or element is concurrent or contiguous, or integrally formed, with the input part of a succeeding unit or element of the apparatus. As an illustrative example, the single-photon source, the polariser and the polarisation rotator may each comprise a photonic crystal structure (see below), and this may be a continuous structure shared between two or more of these components/units such that the optical output part of one is contiguous/continuous with the optical input part of another. Alternatively, or one or more of these components/units may comprise an individual photonic crystal structure separate from that of one or more of the other components/units, as may be appropriate or desirable in some embodiments.

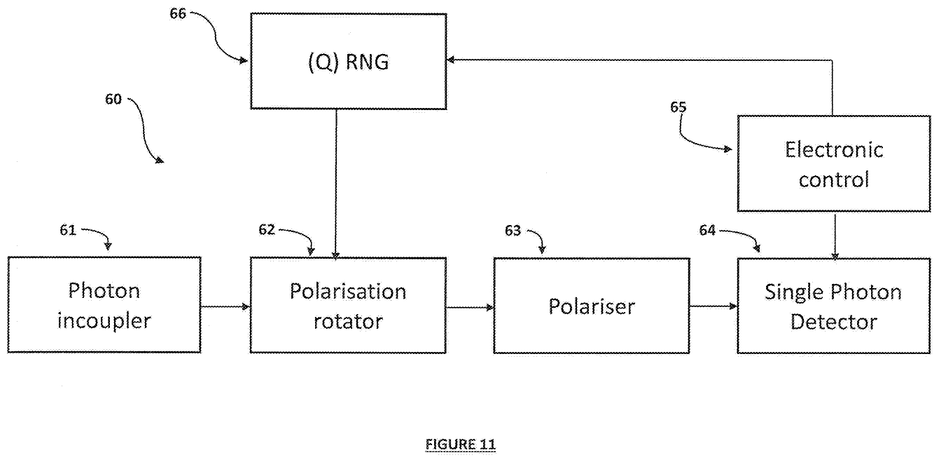

The polarisation rotator 5 is, in effect, a “waveplate” which is able to rotate the linear polarisation state of the photon. Using the polarisation rotator, the apparatus is arranged to create two different polarisation basis sets (e.g. any desired combination of two of: “rectilinear basis”; “diagonal basis”; “circular basis”) using just one incoming linear polarisation state received from the polariser 4, by applying a selected birefringence at the polarisation rotator. These bases are used by the apparatus in the distribution of a cryptographic key using, for example, a BB84 protocol. This is discussed in more detail below. A single polarisation rotator 5 (or item 62 of FIG. 11), is able to provide photons in any one of four separate polarisation states. For example, two orthogonal polarisation states (diagonal linear polarisation and anti-diagonal linear polarisation states) may be employed to create a “diagonal basis”, and another two orthogonal circular polarisation states (right-circular polarised and left-circular polarised states) may be used to create a second basis. These two bases provide the required two bases for use in BB84 protocols. As an alternative to diagonal/anti-diagonal polarisation states for a basis, one may use horizontal and vertical states of linear polarisation as a “rectilinear basis”, for use in conjunction with right-circular and left-circular states.

A random number generator unit 6 is arranged in communication with both the electronic control unit 3 and the polarisation rotator 5, and is arranged to receive control signals from the electronic control unit 3 and to transmit control signals to the polarisation rotator 5 to control the operation of the polarisation rotator. The Electronic control may include a memory unit and a central processing unit. The sequence of bits output by the random number generator unit, that are used to perform the polarisations rotations, are stored in the memory. The CPU of the electronic control may be used to perform error correction and privacy amplification algorithms. In particular, the electronic control unit 3 is arranged to issue a command signal to the random number generator 6 to which the random number generator is responsive to generate a basis command signal for transmission to the polarisation rotator, and synchronously to issue an electrical voltage signal to the single-photon source. The voltage signal comprises a periodic sequence of voltage pulses each designed to cause the single-photon source to generate and output a single photon before arrival of the next voltage pulse. In this way, the command signals to the random number generator are synchronised, by the electronic control unit 3, with the voltage pulses applied at the single photon source, in order to ensure the polarisation rotator applies polarisations to individual photons as they propagate throughout the polarisation rotator. The polarisation rotator 5 is responsive to the concurrent basis command signal from the random number generator 6 to adopt a state which imposes a particular polarisation rotation upon the single-photon output by the single-photon source and subsequently received by the polarisation rotator in a linearly polarised state imposed by the intervening optical polariser 4. In this way, the polarisation rotation imposed upon the single-photon by the polarisation rotator is thereby pre-selected by the basis command signal issued by the random number generator 6.

In this way, the quantum random number generator unit 6 is responsive to a command control signal to apply a randomly selected one of four different voltage control signals to the polarisation rotator 5, and the polarisation rotator is responsive to a voltage control signal to apply an electric field across the field-induced birefringence material disposed within the optical waveguide, to cause the birefringence of that material to change in value by a preselected one of four different amounts. Each change in birefringence value is selected to impose/induce a corresponding one of four different polarisation states to light passing through the material. These four predetermined polarisation states define the four bases for use in a BB84 quantum key distribution protocol, such as would be readily apparent to the skilled person. Other protocols exist, and may be used. Examples are described in the following literature in the art:

The ‘B92’ protocol: Bennett, C., “Quantum cryptography using any two non-orthogonal states.”, Phys. Rev. Lett. 68, 1992, pp. 3121-3124. This is essentially a simplified version of the BB84 protocol.

The ‘SSP99’ protocol: Bechmann-Pasquinucci, H., and Gisin, N., “Incoherent and coherent eavesdropping in the six-state protocol of quantum cryptography.” Phys. Rev. A 59, 4238-4248, 1999. This protocol increases the number of states used and has been shown to increase security. It can also be used to increase the number of valid recipients. Thus, four photon states (polarisation/phase etc.) are not a minimum/maximum requirement of quantum key distribution protocols applicable to the present invention.

Preferably, the random number generator is a quantum random number generator (QRNG). It is non-deterministic. Quantum random number generators use quantum mechanical effects to produce random numbers. This makes a quantum random number generator distinct from so-called pseudo random number generators (PRNG) which produce random numbers using a deterministic algorithm. In particular, a quantum random number generator generates a random number using the unpredictability of quantum mechanical events. A suitable quantum random number generator for use in the random number generator unit 6, will be readily available and apparent to the skilled person, and may be selected, for example, from the examples disclosed in the following review article:

M. Herrero-Collantes and J. C. Garcia-Escartin: Quantum Random Number Generators: Reviews of Modern Physics; Volume 89, No. 1, January-March 2017 (DOI: 10.1103/RevModPhys.89.015004)

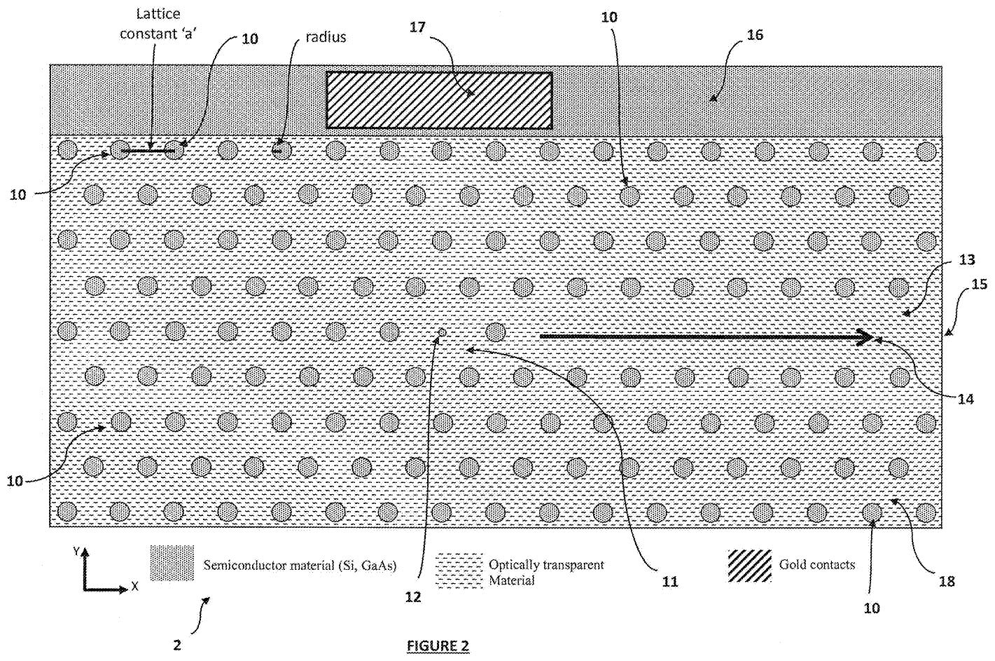

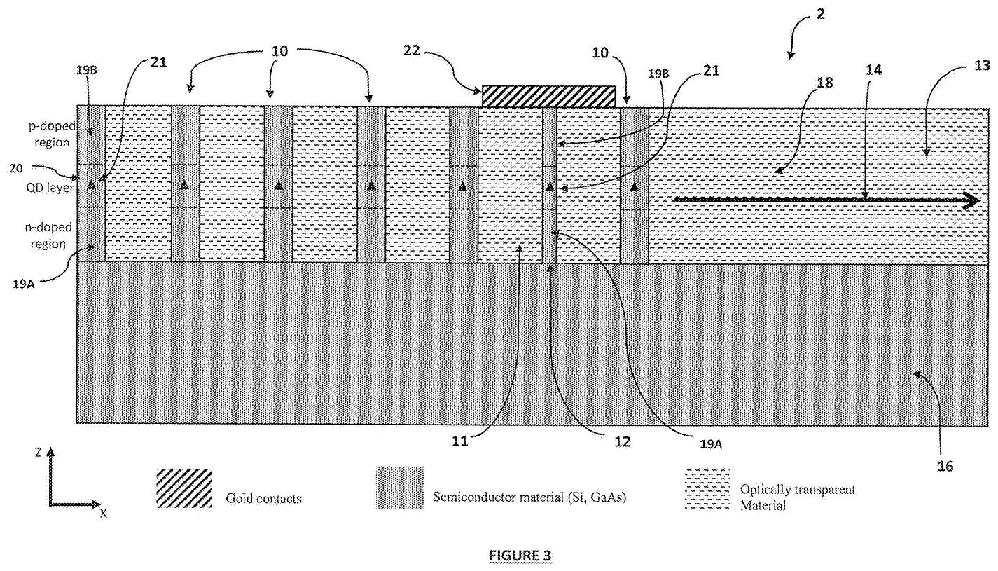

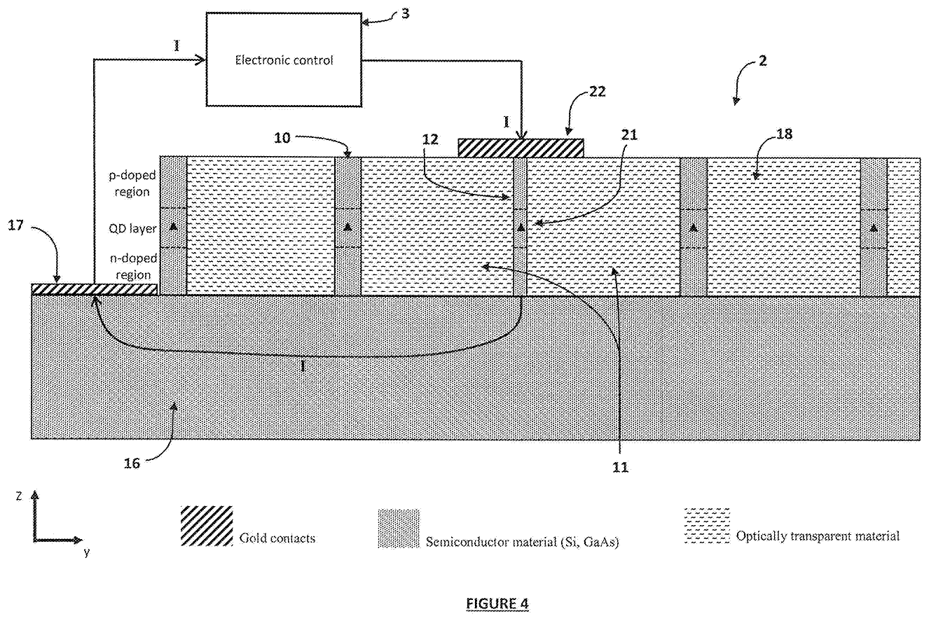

FIGS. 2, 3 and 4 schematically illustrate a plan view and a side view, both in cross-section, of a preferred embodiment of the single-photon source 2 employed in one implementation of the quantum key distribution transmitter 1, of FIG. 1. The single-photon source comprises a photonic crystal defined by a regular and periodic two-dimensional array of parallel, cylindrical dielectric rods 10 of common radius, laterally offset from one another, neighbour-to-neighbour, by a common spacing defining the “lattice constant” (‘a’) of the photonic crystal.

### Photonic Crystals

A crystal is a periodic arrangement of atoms or molecules. The pattern with which the atoms or molecules are repeated defines the crystal lattice. The crystal presents a periodic electrical potential to an electron propagating through it, and both the constituents of the crystal and the geometry of the lattice dictate the conduction properties of the crystal. Electrons propagate as waves within the crystal, according to quantum mechanics, and waves that meet certain criteria are permitted to travel through the periodic potential of the crystal lattice without scattering. This causes the crystal to be conducting.

However, the crystal lattice can also prohibit the propagation of certain electron waves, and this may present a gap in the energy band structure of the crystal, meaning that electrons are forbidden to propagate within the crystal with certain energies in certain directions. This is the basis of a “bandgap” in, for example, a semiconductor which exists between the valence band and the conduction energy bands of the semiconductor crystal.

An optical analogue of this structure is known as a “photonic crystal”. Whereas the conductive, or semi-conductive, properties of a conducting crystal are determined by the periodic arrangement of its atoms and molecules, the analogous optical properties of a photonic crystal are determined by the periodic arrangement of the dielectric constant (or refractive index) of the material of the crystal. In a photonic crystal, the complicated interplay of refractions and reflections of light from all of the variations in dielectric constant within the crystal can produce many of the same phenomena for photons that the variations in atomic potentials can produce for electrons. In particular photonic crystals can be constructed to possess “photonic band gaps” preventing light from propagating in certain directions with specified frequencies.

As is well-known, the propagation of light within a photonic crystal is governed by the Maxwell equations, which are:

$$∇ \cdot B = 0 ; ∇ \times E + \frac{\partial B}{\partial t} = 0$$

$$∇ \cdot D = ρ ; ∇ \times H - \frac{\partial D}{\partial t} = J$$

where E and H of the microscopic electric and magnetic fields, D and B of the displacement and magnetic induction fields, and ρ and J are the free charge and current densities, respectively.

In a photonic crystal, where the dielectric constant varies with spatial position, but not with time, we have and ρ=0 and J=0. Furthermore, E and D are related by the “dielectric function”, ε(r), while H and B are related by the “relative magnetic permeability”, μ(r), as follows:

B(r)=μ₀μ(r)H(r); D(r)=ε₀ε(r)ε(r)

where μ₀ and ε₀ are the vacuum permeability and permittivity, respectively. This means that the above Maxwell's equations become:

$$∇ \cdot H ( r , t ) = 0 ; ∇ \times E ( r , t ) + {μ}_{0} \frac{\partial H ( r , t )}{\partial t} = 0$$

$$∇ \cdot [ ɛ ( r ) E ( r , t ) ] = 0 ; ∇ \times H ( r , t ) - {ɛ}_{0} ɛ ( r ) \frac{\partial E ( r , t )}{\partial t} = 0$$

The time dependence and space dependence of these expressions can be separated, by expressing the electric and magnetic fields as a set of harmonic modes:

H(r,t)=H(r)e^{-iωt}; ε(r,t)=ε(r)e^{-iωt}

This then results in the above expressions being reduced to the following relation for the magnetic field component of the electromagnetic wave in the photonic crystal:

$$∇ \times ( \frac{1}{ɛ ( r )} ∇ \times H ( r ) ) = {( \frac{ω}{c} )}^{2} H ( r )$$

With this equation, for a given structure, or lattice, of dielectric constant defined by the spatial distribution ε(r), it is possible to solve the equation to find the allowed modes or “eigenstates” of the magnetic field H(r), and their corresponding frequencies. From this, the electric field modes, E(r), of the light field are directly obtained from:

$$E ( r ) = \frac{1}{{ωɛ}_{0} ɛ ( r )} ∇ \times H ( r )$$

Accordingly, the spatial structure of the dielectric function, ε(r), is carefully selected to directly determine the spatial structure of the electromagnetic field modes permitted within it. In the photonic crystal structures employed in preferred embodiments, such as discussed herein, a 2-dimensional photonic crystal is employed. This is a structure which is periodic along two of its axes (e.g. the x and y axes) and homogeneous along the third axis (e.g. the z axis). The photonic crystal of FIGS. 2 to 4, and all other examples of photonic crystals described in the illustrated embodiments herein, is a 2-dimensional photonic crystal in this sense. The photonic crystal comprises a triangular lattice of dielectric columns 10 (other lattice geometries are possible). In this case, the dielectric function is periodic such that, ε(r)=ε(r+R) in which R is a vector lying within the x-y play of the photonic crystal and is any linear combination of the primitive lattice vectors of the photonic crystal (e.g. the vectors defining the separation between successive dielectric columns of the lattice, in orthogonal directions). The direct consequence of this periodicity is that the magnetic field modes are so-called Bloch states:

H(r)=e^{-ik}^{_{∥}}^{ρ}e^{-iz}u(ρ)

Here, ρ is the projection of the position r in the x-y plane of the photonic crystal, k_{∥} is the projection of the wave vector of the electromagnetic mode on to the x-y plane of the photonic crystal, k_{z} is the component of that wave vector perpendicular to the crystal plane (|k|=nω/c, where n is the refractive index of the dielectric material forming the dielectric rods 10, and c is a speed of light in a vacuum). The function u(ρ) is a periodic function u(ρ)=u(ρ+R).

For certain values of column spacing (i.e. Lattice constant ‘a’), and/or column thickness/radius, such a photonic crystal has a photonic band gap in respect of light propagation within the x-y plane. Within this bandgap, no extended electromagnetic field modes are permitted and incident light is reflected. This photonic crystal can prevent light from propagating in any direction within the x-y plane where this regular crystal structure is present and crystal defects are absent. The photonic crystal structures employed in preferred embodiments of the invention are defined and expressed in terms of the dielectric function, ε(r), which has been carefully chosen so that the photonic crystal particularly supports desirable electromagnetic field modes which confine and/or direct individual photons in a specific and carefully controlled manner desirable to achieve the effects of the invention.

In particular, the photonic crystal structure employed in the single-photon source 2 is designed to comprise two deliberate crystal defects as follows. A first crystal defect comprises the presence of a cylindrical dielectric rod 12 arranged to conform to the periodic arrangement of the array of cylindrical dielectric rods of the crystal, yet being structured to have a cylinder radius which is significantly smaller than the cylinder radius of the other dielectric rods of the photonic crystal. The effect of this is to define an optical cavity 11 in which the thinner rod 12 is centred, and surrounded by six immediately neighbouring rods 10 each spaced from the thinner rod, and from one another, by the same lattice constant (“a”). The optical cavity is therefore predisposed to support optical “cavity modes” of electromagnetic radiation within the photonic crystal, which allow a limited confinement of individual photons within the cavity, as will be explained in more detail below.

A second crystal defect comprises a linear defect in which a linear succession of cylindrical dielectric rods of the crystal are wholly absent from the periodic array of rods. The effect is that, at a linear succession of locations within the lattice structure of the photonic crystal which conform to the lattice periodicity, dielectric rods are absent where they would otherwise be expected to be present. The linear defect extends from an inner terminal end point located within the lattice structure of the photonic crystal, to an open end formed at a boundary edge of the photonic crystal. The inner terminal end of the linear defect is bounded by a dielectric column of the photonic crystal, from which the regular crystal lattice structure of the photonic crystal resumes. In other embodiments, the lattice defect defining the waveguide may be formed by other means such as a series of rods with different diameters from the lattice. Conversely, the open end of the linear defect is not bounded by a dielectric column. The effect of this linear defect is to define an optical waveguide 13 and, in the particular photonic crystal structure and linear defect arrangement of the present embodiment, to define a single-mode optical waveguide. In other embodiments, the waveguide may be a multi-mode optical waveguide, and this may be useful when using the system to implement wavelength-division multiplexing (WDM) for quantum key distribution. The linear defect is therefore predisposed to support travelling modes of electromagnetic radiation within the photonic crystal which allows light to propagate along the linear defect in a direction 14 towards an optical output part (e.g. output port) 15 of the single-photon source.

It is important to note that confinement of light within either the optical cavity of the photonic crystal, or the optical waveguide of the photonic crystal, is not achieved by process of internal reflection. Rather, it is achieved because the light modes permitted within the optical cavity or waveguide reside within the photonic band gap of the photonic crystal, meaning that they are not permitted modes within the photonic crystal itself.

The optical cavity 11, the thin dielectric column 12 centred within the optical cavity, and the linear axis of the linear defect defining the single-mode waveguide, are all aligned in co-linear alignment. The innermost terminal end of the linear defect, within the photonic crystal lattice, is separated from the optical cavity by a single dielectric column 10. This close separation between the optical cavity and the single-mode waveguide has the effect of enabling an optical coupling between the optical cavity and the single-mode waveguide. In particular optical cavity modes present within the optical cavity are permitted to “leak” into the single-mode optical waveguide. The effect is that individual photons present in the optical cavity are able to enter the single-mode waveguide and to propagate along the axis of the waveguide for output from the single-photon source.

An optically transparent material (optionally a field-induced birefringence material) 18 fills the photonic crystal lattice structure, occupying the voids between dielectric columns 10. The refractive index of the optically transparent material is significantly less than the refractive index of the dielectric columns 10 of the photonic crystal lattice. This ensures a strong refractive index contrast between the dielectric columns and the optically transparent material, within the photonic crystal.

In FIG. 1, the single-photon source is shown schematically as a separate unit from the polariser 4 and the polarisation rotator 5. However, it is to be understood that while the units shown separately in FIG. 1, in schematic form, may be implemented as separate units, in preferred embodiments of the invention these functional units may be integrated into one continuous structure. The field induced birefringence material within the photonic crystal of the single-photon source, may be omitted in other embodiments. However, in some embodiments such as the embodiment illustrated in FIGS. 2, 3 and 4, the field induced birefringence material is included to fill the gaps between dielectric columns of the photonic crystal. The refractive index of the field induced birefringence material alone (i.e. independently of the birefringence properties of the material) may be desirable in preference to empty, air-filled gaps between columns, so as to allow a control over the overall optical properties and performance of the photonic crystal. This feature of some embodiments of the invention permits greater design flexibility and optimisation in this sense. This also applies to the presence of the field induced birefringence material in the polariser unit 4 and the polarisation rotator 5.

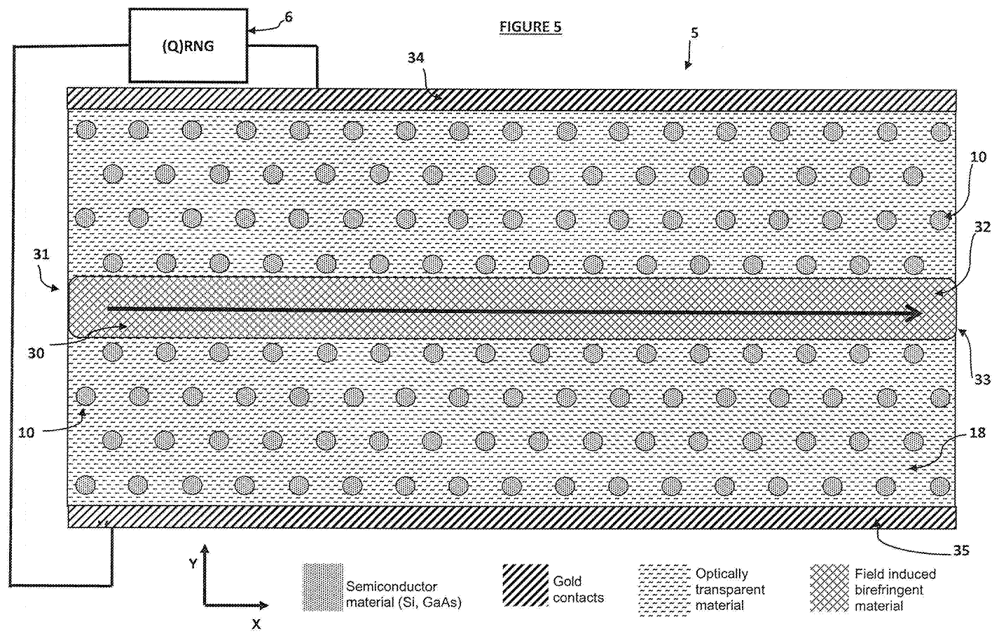

The application of an electrical field to induce the desired field-induced birefringence within the birefringence material may be provided by locally placed field-generating electrodes dedicated for that purpose, such as electrode contacts of the polarisation rotator discussed with reference to FIG. 5. Electrical current drive electrodes (17, 22) provided in the single-photon source (see below; FIG. 2 to 4) for providing a flow of current through a dielectric column of the photonic crystal within the optical cavity, may be spatially separated from such field-generating electrodes (which do not support a flow of current through the birefringence material) to avoid any electrical interference. The electric field may be applied vertically (i.e. in the z-direction) by fabricating one electrode above the waveguide (and the other beside the waveguide) or laterally (i.e. parallel to the x-y plane) by fabricating both electrodes on each side of the waveguide.

Each dielectric column (10, 12) of the photonic crystal comprises a layered structure having three distinct layers of semiconductor material forming a p-i-n semiconductor switch arrangement. In particular, a base column portion 19A of each dielectric column is formed from an n-doped semiconductor material (i.e. comprising negatively charged majority carriers), upon which is formed a mid-column portion 20 which is formed from an intrinsic semiconductor material (i.e. not doped) or from a relatively very lightly doped semiconductor material. A top column portion 19B is formed on top of the mid-column portion thereby to sandwich the mid-column portion between the base and top colour portions. The top column portion is formed from a p-doped semiconductor material (i.e. comprising positively charged majority carriers). A quantum dot structure 21 is formed within each respective dielectric column of the photonic crystal, being embedded within the intrinsic semiconductor material of the mid-column portion 20.

Each dielectric column of the photonic crystal is formed upon, and extends perpendicularly from a common planar surface of, a silicon (Si) substrate 16. A first electrical drive contact electrode 22 is formed in electrical communication with the terminal top end of the thin dielectric column 12 centred within the optical cavity 11 so as to be in conductive electrical contact with the p-doped top column portion thereof. Most importantly, the first electrical drive contact electrode 22 is structured and arranged so that the dielectric column with which it forms an electrical contact, is limited only to the thin dielectric column 12 centred within the centre of the optical cavity. This is to ensure that a path of current flowing between the two electrical drive electrodes passes only through the thin dielectric column 12, and does not pass through any of the other dielectric columns 10, which also contain quantum dots. The purpose is to ensure that the drive electrodes only provide current flow through the quantum dot located within the centre of the optical cavity, and that they do not provide current to any of the other quantum dots within other dielectric columns 10.

A second electrical drive contact electrode 17 is formed electrical communication with the planar surface of the silicon substrate from which the dielectric columns of the photonic crystal extend. The second electrode 17 extends across the surface of the silicon substrate in a direction parallel to one side of the photonic crystal lattice structure directly adjacent to the column base portions 19A of five of the dielectric columns 10 residing nearest the thin dielectric column 12 of the optical cavity 11. Both the first and the second electrode are in electrical communication with the electronic control unit 3 of the quantum key distribution transmitter system 1, and are arranged to form an electrically conductive path/circuit for the flow of current through the electronic control unit, to the first electrical drive contact electrode 22, onward through the p-i-n semiconductor structure of the thin dielectric column 12 (and the quantum dot 21 within it), thence to the second electrical drive contact electrode 17 via the silicon substrate 16, and back to the electronic control unit 3. In this way, an electrical circuit is provided which enables charge carriers to flow into the intrinsic semiconductor of the mid-column portion of the thin dielectric column 12, in response to appropriate voltage signals applied to the thin dielectric column 12 by the electronic control unit 3.

In this way, the ability to supply current to the thin dielectric column 12 enables the quantum dot 21 to be electrically pumped into an excited state in which an exciton (electron-hole pair) is bound within the atom-like structure of the quantum dot in an excited state from which it may decay and emit a single photon in the process. Consequently, this arrangement allows direct electrical control of a single-photon emitter for the emission of individual photons, one-by-one, as and when required.

The structure/properties of the quantum dot are selected so that the wavelength of light that it emits is predisposed to be consistent with the optical mode supported by the optical cavity. In this way the quantum dot is engineered to be “sympathetic” to the structure and properties of the optical cavity. Of course, the quantum dot could be replaced by a quantum well, or a light-emitting diode (LED). Whichever type of emitter is employed (dot/well/LED), the emission wavelength of the emitter is designed preferably to be substantially the same as that of the cavity mode. In a low-Q cavity (a preferred feature of embodiments) the cavity mode's linewidth is typically relatively broad, e.g. 100 nm or more. This has the benefit of allowing emitters having an emission wavelength that need only fall within the required bandwidth of the cavity which, being broad, permits a broader range of emitters to be employed and relieves one from the burden of otherwise requiring far more precise manufacturing tolerances with respect to the emission wavelength. For example, this permits the use of self-assembled quantum dots in manufacturing the single-photon source. It is possible to growth self-assembled quantum dots in such a way so as the emission width of the ensemble of such quantum dots is less than the cavity width. Accordingly, when one then takes any single quantum dot from the resulting ensemble, for use in the optical cavity, one can be assured that there will be an optical coupling of that quantum dot to the cavity mode.

### Single Photon Emitter

An ideal single-photon light source would be arranged to emit a single photon with certainty, when triggered to do so, while reliably not emitting more than one photon at that time. A light source in a coherent state has a mean photon number determined according to a Poisson probability distribution which has a non-zero and significant probability of containing more than one photon. No matter how much the intensity of the light source is reduced, there is always a non-zero probability of the light source containing more than one photon. Accordingly, the invention, in preferred embodiments, employs a single-photon source preferably comprising an atom-like system, or quantum system, which can be controlled to emit single photons as and when required.

The photon emission rate of such a single-photon source is controlled by the emission lifetime of the source, and this is characteristic to the spontaneous emission rate of the light emitter used by the source. As an example, a quantum, or atom-like emitter residing within a medium of refractive index n will possess a spontaneous emission rate (Γ) determined by the transition dipole moment (μ_{eg}), and the transition frequency (ω) between the ground state and the excited state of the atom-like emitter:

$$Γ = \frac{4}{3 n} \frac{{μ}_{eg}^{2}}{4 {πɛ}_{0} ℏ} {( \frac{ω}{c} )}^{3}$$

High photon emission rates may be preferable to permit high data rates, of the order of 10 Gbps, when the single-photon source is used for quantum key distribution (QKD). As discussed above, quantum key distribution is a method of secretly exchanging cryptographic keys between two separated partners, traditionally referred to as Alice and Bob, in the presence of an eavesdropper, typically referred to as Eve. It is impossible to directly measure a quantum-mechanical state without changing it, and protocols of quantum key distribution take advantage of this fact. In particular, quantum mechanical objects can exist in the superposition of states that collapses when observed. In the case of QKD, this property enables the presence of an eavesdropper to be detected on a secure connection. This is because the state observed by the eavesdropper will collapse when observed by them. This collapse reveals itself to the users of the secure connection. A well-known example of a QKD protocol, exploiting this property, was proposed by Bennett and Brassard in 1984, and is called the BB84 protocol. In practice, this protocol may be implemented using single photons each existing in a superposition of linear, or circular polarisation states. A single-photon source is useful for this application.

In preferred embodiments of the invention, such as illustrated in FIGS. 2, 3 and 4, a quantum dot emitter 21 (e.g. InAs/GaAs, or InP/GaInP) is used in conjunction with an optical cavity 11 defined within a photonic crystal. A number of different types of semiconductor composition could be used for the quantum dot, or for a quantum well if used in place of a quantum dot. Examples include: In(Ga)As for a quantum dot, or a quantum well in GaAs, with e.g. an Al(Ga)As barrier material. Other options include InAs/GaAs, or InP/GaInP. The quantum dot 21 possesses exciton states (e.g. two degenerate and orthogonally polarised one-exciton states) from which single-photon emission can be generated. While the quantum dot, in isolation, may not emit photons with any preferential polarisation state, this is not the case when the quantum dot emitter is coupled optically to the optical cavity. When optical coupling to the optical cavity is provided, as in preferred embodiments, the single-photon emission from the quantum dot 21, into the optical mode of the cavity 11, is preferentially polarised.

Electrical pumping of the quantum dot 21 is achieved by arranging (e.g. growing) the quantum dot structure grown within the intrinsic semiconductor layer 20 of the p-i-n junction of the layered semiconductor structure forming the thin central dielectric column 12 of the photonic crystal. By applying a short electrical pulse to the p-i-n junction, the electronic control unit 3 is arranged to cause electrons and holes to cross the junction into the intrinsic semiconductor layer 20, and to enter into the quantum dot 21 located there. For example, a quantum dot may provide electrically pumped single-photon emission in this way, at speeds of up to several hundred MHz.

For example, the magnitude of the pumping current for the quantum dot, and the repetition rate/frequency at which one may preferably apply the pumping current pulses, may be optimised. The voltage applied to the quantum dot is preferably above the quantum confined exciton's energy in the dot/well (resonant excitation), or optionally above the bandgap of the bulk semiconductor (non-resonant) of the structure. In preferred embodiments, the voltage may be about 1.5V. The repetition rate of the voltage pulses may preferably be between 1 MHz and a few GHz. The internal quantum efficiency can be very high, so the applied current resulting from this could be as low as the product of the repetition rate and the electron charge.

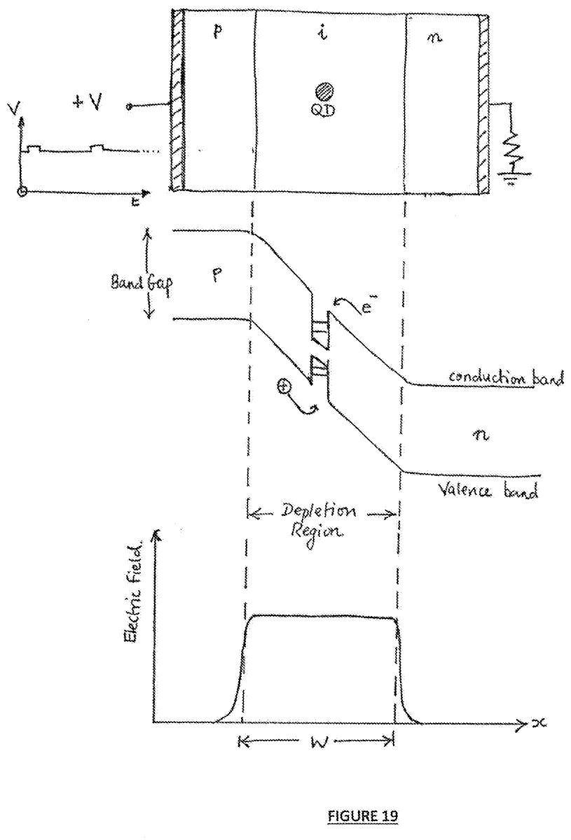

FIG. 19 schematically illustrates energy band structure of the p-i-n junction of the thin dielectric column 12 and the first and second drive electrodes (22, 17) electrically coupled to it. The intrinsic semiconductor region is sandwiched between the p-doped semiconductor layer and the n-doped semiconductor layer. In practice, however, the idealised intrinsic region may be approximated by either a high-resistivity n-doped layer or a high-resistive n-doped layer. The junction operates as a switch able to be switched from a non-conducting state to a conducting state by application of a voltage (V) to the p-doped end of the column, via the first drive electrode 22. The switching speed of such a switch is approximately proportional to the width of the intrinsic layer (W) of the junction and so an appropriate switching speed can be provided by an appropriate choice of the intrinsic layer width (W). The relatively small volume of the central column 12 of the photonic crystal cavity, as compared to neighbouring columns, not only defines an optical cavity 11 within the photonic crystal, but also assists with providing a fast switching of the p-i-n junction within the column containing the quantum dot emitter. In particular, the smaller volume of the central column has an impact on how quickly the p-i-n junction can transition from a non-conducting state to a conducting state, and back again. The fast switching of the p-i-n junction allows the quantum dot pumping to occur over a short time interval. In preferred embodiments, the p-i-n junction may be driven with drive voltage pulses of small amplitude (quick switching) superimposed upon a DC bias set to just below the p-i-n switching threshold voltage. In preferred embodiments, the amplitude of the drive voltage pulses may be substantially the smallest possible amplitude (or a few percent, or less than 10%, above that smallest amplitude) of AC drive pulse needed to induce emission. This way the device can be operated more quickly. The diameter of the central dielectric column of the optical cavity may preferably be designed, optimised, or selected to allow, or ensure, an optical mode within the cavity that has the desired Q-value. This provides a design variable to allow a suitable Q-value to be achieved.

FIG. 19 schematically illustrates the electrical field distributed across the intrinsic layer of the junction caused by the space-charge density differential as between the p-doped layer and the n-doped layer. The potential well structure defined by the quantum dot embedded within the intrinsic layer is also schematically shown and this potential well comprises a quantum well formed within the conduction band of the intrinsic semiconductor, and a corresponding quantum well, formed within the valence band of the intrinsic semiconductor. Each quantum well possesses one or more quantum bound states within it, which support an exciton (electron-hole pair).

When a drive voltage (V) is applied to the p-doped end of the thin column 12 of the photonic crystal, by the first drive electrodes 22, the p-i-n junction responds in one of two ways depending on the magnitude of the drive voltage. If the drive voltage is below the threshold voltage (V₀) required to cause the p-i-n junction to become conductive, then no flow of charge carriers occurs through the intrinsic layer 20 of the p-i-n junction. However, as soon as the drive voltage is increased to a value exceeding the threshold voltage (V₀) of the p-i-n junction, that junction comes conductive and a flow of charge carriers is driven across the junction and across the quantum dot embedded within it. Consequently, the quantum dot 21 is able to be filled with one or more electrons entering the quantum well structure formed in the conduction band, and corresponding holes are able to enter the corresponding quantum well formed within the valence band. In this way, the quantum bound states of the quantum dot are caused to be occupied.

Consequently, the electronic control unit 3 is arranged to electrically drive/pump the quantum dot in this manner by applying a pulsed voltage signal to the first drive electrode 22. The voltage signal comprises a DC voltage level which is just below the threshold voltage of the p-i-n junction, modulated by brief rectangular pulses each of sufficient magnitude to lift the applied voltage to just above the threshold voltage of the p-i-n junction. In this way, the p-i-n junction may be maintained at a voltage level which is nearly, but not quite, sufficient to render the junction conductive, and is briefly and periodically driven to a voltage which is just sufficient to render the junction conductive, but only during the existence of the brief rectangular pulse.

When the quantum dot is pumped in this manner, such that the bound states of the dot are populated by an exciton, the quantum dot then has a finite lifetime within this excited state, after which it will decay by emission of a single-photon as the electron-hole pair of the exciton transition from the excited state to a lower energy state. This provides a single-photon emitter within the optical cavity of the photonic crystal, which then serves to prepare the photon as a cavity optical mode, and via the linear lattice defect subsequently guide to the individual photon through the photonic crystal and out of the single-photon source 2.

Initially, the individual photon emitted by the quantum dot enters the optical cavity of the photonic crystal. The coupling of a single-photon emitter to an optical cavity mode is in part determined by the position of the emitter relative to the position of the maximum amplitude of the optical field within the cavity. The coupling of a single-photon emitter into an optical cavity has the desirable result of permitting higher repetition rates and high quantum efficiencies. The quantum efficiency can be viewed as the product of the coupling efficiency of the single-photon emitter to the optical cavity mode, and the extraction efficiency of the single-photon into a travelling wave mode. Given that a quantum dot will randomly emit single photons isotropically, coupling to a cavity will direct this emission into the cavity mode, which is coupled to a waveguide for supporting travelling wave modes. Furthermore, the optical cavity mode may present a well-defined and desirable optical polarisation state, which is useful in quantum key distribution applications.

Photonic crystal optical cavities provide cavity structures characterised by well-defined spectral and spatial mode profiles with light confinement properties. The coupling of a light field as between a quantum dot emitter and an optical cavity, depends on the properties of the emitter and the cavity. When a strong coupling exists, coherent coupling between the quantum dot and the cavity optical field is stronger than the coupling to other radiative optical modes. The emitter/cavity system oscillates between: (a) a state |e,n [symbol] in which the quantum dot is excited and the cavity contains n photons; and, (b) a state |g,n+1 [symbol] in which the quantum dot is in the ground state and the cavity contains (n+1) photons. The strength of this coupling is determined by the coupling parameter between the quantum dot single-photon emitter and the optical cavity as follows:

$$g ( \vec{r} ) = \frac{\vert {\vec{μ}}_{eg} \vert}{ℏ} \sqrt{\frac{ℏω}{2 {ɛ}_{M} {V}_{mode}}} ψ ( \vec{r} ) cos ( ξ )$$

$$where$$

$$ψ ( \vec{r} ) = \frac{E ( \vec{r} )}{\vert {E}_{max} \vert}$$

$$and$$

$$cos ( ξ ) = \frac{{\vec{μ}}_{eg} \cdot \hat{e}}{\vert {\vec{μ}}_{eg} \vert}$$

Here ω is the angular frequency of the optical field supported by cavity, \vec{μ}_{eg} is the quantum dot dipole moment, V_{mode} is the cavity mode volume, ε_{M} is the permittivity of the material of the cavity when the electric field component of the optical field is a maximum, and r is the location of the quantum dot single-photon emitter within the cavity. The value of ψ(\vec{r}) gives the relative strength of the electric field at the location of the quantum dot emitter, compared to the maximum strength of the electric field component. The cos(ξ) term expresses the fraction of the dipole moment along the direction of the electric field component of the optical field. In many existing optical technologies incorporating an emitter within an optical cavity, a driving motivation is to achieve the highest possible value of Q (e.g. a value of hundreds of thousands). However, this demands the effort and expense of optimising the values for the parameters: V_{mode}, ψ(\vec{r}), cos(ξ), Γ, and κ. Great care is demanded to ensure that the quantum dot is most optimally coupled to the optical cavity. In a sharp departure for this prejudice in the field, the inventors have realised that the values of the parameters need not be tightly constrained in this way, since in preferred embodiments, the optical cavity/emitter is arranged to operate in the weak coupling regime. Feedback from the cavity to the exciton is not required. The cavity is desirably designed to be, purposefully, relatively “leaky” such that the quality factor, Q, is preferably low, preferably being in the range: 1<Q<10000; or 1<Q<5000; or 1<Q<1000; or 1<Q<500; or 1<Q<400; or 1<Q<300; or 1<Q<200. This condition gives a broad cavity mode and the quantum dot's emission's linewidth is, in preferred embodiments, many times narrower than this. In preferred embodiments, the cavity mode volume is also very large relative to the quantum dot's confinement potential. The Q-value can be changed, optimised or selected by altering the radii and positions of the lattice cells surrounding, or defining the periphery of, the optical cavity relative to the rest if the photonic crystal lattice, thereby further breaking the symmetry of the photonic crystal there.

The condition for week coupling depends on the strength of this coupling parameter as follows:

Γ<|g|<κ/2

where κ is the cavity field decay rate (κ=ω/2Q) and Γ is the decay rate of the quantum dot single-photon emitter. A typical value of a cavity decay rate may be of the order of 100 μeV, equating to a cavity lifetime (1/κ) of the order of a picosecond. The decay rate of a quantum dot may be of the order of several μeV, equating to an exciton lifetime of the order of a nanosecond. This means that once the exciton has decayed and emitted a photon into the cavity, the cavity then very quickly emits the photon.

Thus, the weak coupling regime is achieved by reducing the Q-factor and/or increasing the cavity mode volume. Positioning the quantum dot (particularly, the exciton within it) at the location of the maximum field intensity, and/or aligning the excitonic dipole moment with the cavity field polarisation, will tend to increase the coupling between the emitter and the optical cavity. Consequently, deviations from such precise positioning or alignment will have the effect of reducing the coupling in question. Accordingly, the weak coupling regime can be achieved by employing a relatively “leaky” optical cavity in which irreversible decay rates dominate over the coherent coupling rate and the exciton-cavity system has insufficient time to couple coherently before a photon escapes from the cavity. The spontaneous emission rate of the quantum dot (i.e. the exciton within it) is then given by

$$Γ = 2 ℏ {\vert {μ}_{eg} \vert}^{2} \frac{Q}{{ɛ}_{M} {V}_{mode}} {ψ}^{2} ( \vec{r} ) {cos}^{2} ( ξ ) \cdot \frac{{( {Δλ}_{c} )}^{2}}{4 {( λ - {λ}_{c} )}^{2} + {( {Δλ}_{c} )}^{2}}$$

Where λ_{c} is the cavity resonance wavelength and

$${Δλ}_{c} = \frac{{λ}_{c}}{Q}$$

is the cavity line width. The cavity linewidth preferably is large, and may be in the range: 10 meV<Δλ_{c}<100 meV; or 10 meV<Δλ_{c}<80 meV; or 10 meV<ΔΔ_{c}<60 meV; or 10 meV<Δλ_{c}<40 meV; or 10 meV<Δλ_{c}<30 meV. As a result of the breadth, the emission wavelength of the quantum dot need not be precisely close to the centre wavelength of the cavity linewidth, yet will remain effective.

As discussed in detail above, term “photonic crystal” refers to structures with periodic dielectric constants. Electromagnetic wave propagation is prohibited through the photonic crystal in the direction in space through which the periodic crystal lattice structure extends. Planar photonic crystals, such as 2-dimensional (2D) photonic crystal of FIG. 2, have a finite depth in the dimension transverse to the crystal lattice structure, and light confinement within the crystal arises through the combined action of distributed reflections within the 2D crystal lattice structure, and internal reflections in the remaining dimension (i.e. the third dimension). Although not shown in some of the figures herein, for clarity, it will be understood that arrangements are provided to confine light in the third dimension transverse to the plane of the photonic crystal, above the photonic crystal. The substrate (16, 38, 89 etc.) from which the crystal columns extend. This stops light escaping above the tops of the photonic crystal columns. Of course, the substrate also serves this function in the opposite direction. Examples of suitable structures for such confinement include, above the cavity the metal contact 22 used to drive the central column of the optical cavity, and in other regions one may arrange a covering of any suitable material of high refractive index, or contrast in index relative to the optically transparent material in the void parts of the photonic crystal lattice such as would be readily apparent to the skilled person e.g. a dielectric such as SiO₂.

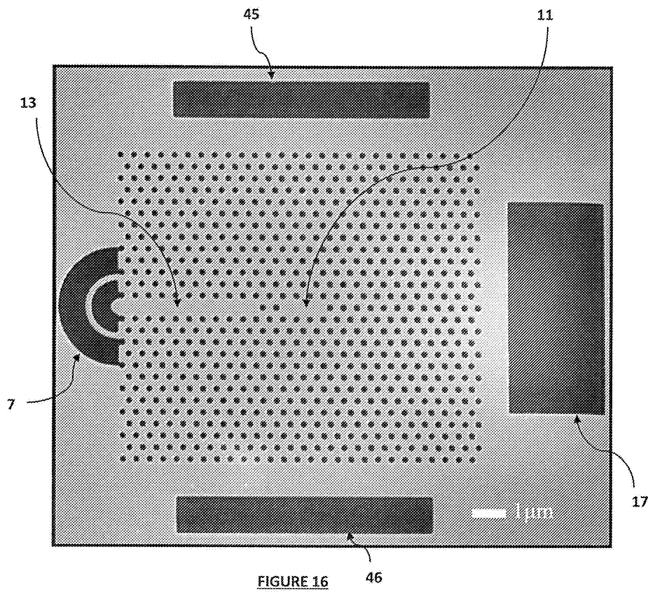

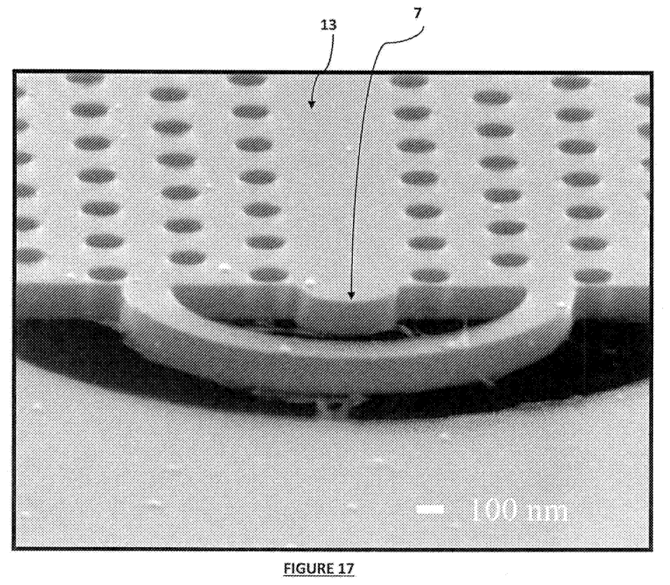

By perturbing a photonic crystal lattice structure, by introducing lattice defects as illustrated in FIG. 2 using the thin dielectric column 12 defining an optical cavity, the invention permits localised optical modes that have frequencies within the photonic band gap. A photonic crystal optical cavity is provided in this way by changing the size of a lattice element relative to other lattice elements. In alternative embodiments and effective crystal defect may be achieved by changing the radius of the hole in a slot-type lattice such as shown in FIG. 16 or FIG. 17, or by changing the refractive index of a dielectric column in a column-type lattice such as shown in FIG. 2.

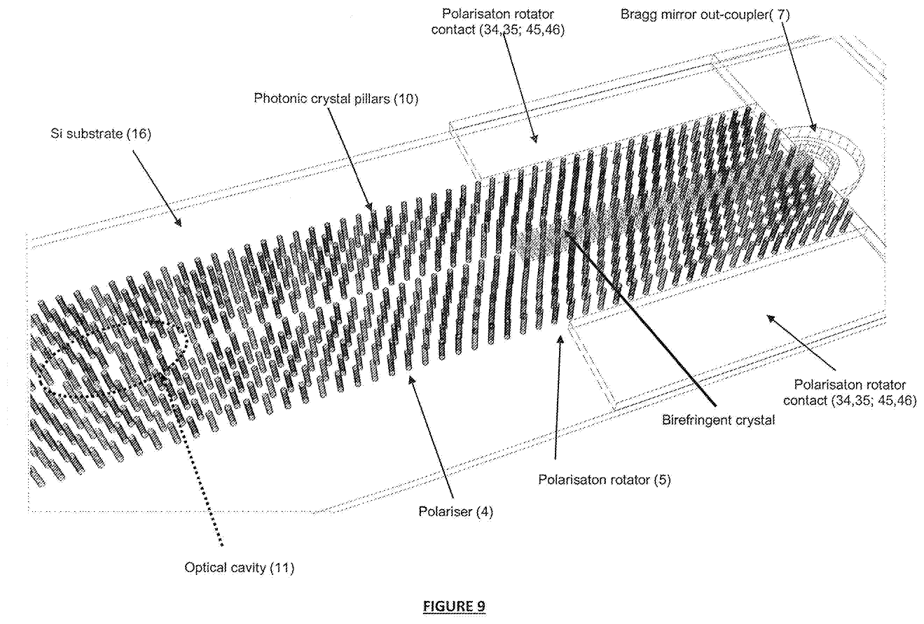

Thus, the lattice defect introduces a peak in the density of optical states inside a photonic band gap. These allowed modes are evanescent within the photonic crystal, such that they decay exponentially away from the crystal defect. In this way, the photonic crystal defect behaves as an optical cavity, and the surrounding photonic crystal lattice structure serves, in effect, as the mirrors of the cavity. However, the presence of only a single dielectric column 10 (or just a few columns; e.g. two—see FIG. 9) separating the optical cavity 11 and the single-mode waveguide 13 of the photonic crystal, renders the optical cavity 11 deliberately “leaky”. Q-factors of photonic crystal cavities can be as high as around 10⁶, however the Q-factor of a photonic crystal optical cavity of preferred embodiments of the invention is typically of the order of 100. That is to say, when an individual photon is emitted by the quantum dot within the optical cavity 11, the Q-factor of the optical cavity is arranged such that there is a high probability that the individual photon has leaked from the optical cavity relatively quickly.

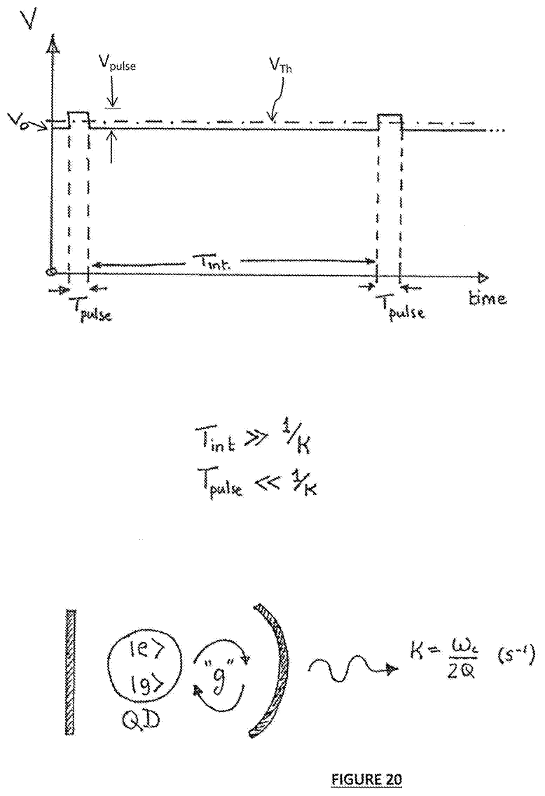

In particular, referring to FIG. 20, there is schematically illustrated a section of drive voltage signal (V) as applied by the electronic control unit 3 to the first driver electrode 22 of the single-photon source, over a period of time encompassing to successive drive/pumping pulses of the electronic control unit. Each rectangular drive/pumping pulse has a duration Tₚᵤₗₛₑ and an amplitude Vₚᵤₗₛₑ during which time the magnitude of the drive voltage is: V=V₀+Vₚᵤₗₛₑ, in which Vₚᵤₗₛₑ is a positive number representing an offset voltage value, and V₀ is a DC voltage level. In between successive drive/pumping pulses, for a time interval Tᵢₙₜ, the magnitude of the drive voltage is a constant DC voltage of magnitude: V=V₀. The DC voltage is, of course, less than the threshold voltage (V_{Th}) during the inter-pulse interval period, such that the p-i-n junction remains non-conducting during that period. However during the relatively short duration Tₚᵤₗₛₑ, the drive voltage exceeds the threshold voltage and the p-i-n junction becomes conductive enabling the quantum dot to be pumped into an excited state. The range of values of V₀ employed, in preferred embodiments, is preferably: 0V to 1.4V. The range of values of Vₚᵤₗₛₑ for use in preferred embodiments is limited by the temperature of operation. Preferably, the value is more than the value kT (k is Boltzmann's constant; T is temperature in Kelvins). Accordingly, the minimum value of Vₚᵤₗₛₑ, may be about 50 mV. The maximum value of Vₚᵤₗₛₑ is influenced by the impedance matching. If this is sub-optimal, then a significant part of an injected voltage pulse can be reflected. Consequently, use of a bigger voltage pulse amplitude than first expected, may be suitable: for example up to about 20V maximum.

The time interval Tₚᵤₗₛₑ is chosen subject to the condition: Tₚᵤₗₛₑ<<1/Γ, where F is the decay rate of the quantum dot from an excited state to its ground state. This condition ensures that the quantum dot is very rapidly pumped to an excited state and, long before it is expected to have decayed, the quantum dot is left unperturbed by the drive voltage signal to allow the quantum dot to decay to a ground state during the subsequent interval time period Tᵢₙₜ. In this way, the invention ensures a high probability that the quantum dot is not pumped twice (or more) by the same single pumping/drive pulse thereby avoiding the likelihood of the quantum dot emitting more than one photon into the optical cavity in response to a single pumping/drive pulse.

The time interval Tᵢₙₜ, is selected to be sufficiently large that there is a high probability that the quantum dot has decayed from its excited state to a lower state, and has emitted a single-photon into the optical cavity 11 within that time interval, and before a subsequent drive/pumping pulse is applied to the quantum dot 21 by the electronic control unit 3. Accordingly, the time interval Tₚᵤₗₛₑ is chosen subject to the condition: Tᵢₙₜ>>1/Γ. Combining these two conditions means that: Tₚᵤₗₛₑ<<1/Γ<<Tᵢₙₜ.

Furthermore, consider the situation in which a single-photon has been emitted by the quantum dot and exists in a cavity mode of the optical cavity. The time interval Tᵢₙₜ, is selected to be sufficiently large that there is a high probability that, within that time interval, the single-photon in question has escaped from the optical cavity 11 and has entered the single-mode optical waveguide 13 of the photonic crystal. Thus, the time interval Tᵢₙₜ is chosen subject to the condition: Tᵢₙₜ>>1/κ, where κ is the cavity field decay rate (κ=ω/2Q), where Q is the Q-factor of the optical cavity and ω is the angular frequency of the cavity mode.

Furthermore, the pulse duration Tₚᵤₗₛₑ is chosen subject to the condition: Tₚᵤₗₛₑ<<1/κ, to be sufficiently short that there is a high probability that the quantum dot is not re-pumped by the pumping/drive pulse after quantum dot has already emitted a single-photon which has already escaped from the optical cavity 11 and has entered the single-mode optical waveguide 13, of the photonic crystal. Combining these 2 conditions, in relation to the optical cavity field decay rate and pump/drive pulse duration gives: Tₚᵤₗₛₑ<<1/κ<<Tᵢₙₜ. FIG. 20 schematically illustrates the relationship between the ground state |g,n+1 [symbol] and the excited state |e,n [symbol] of the quantum dot 21 coupled to the optical cavity 11 via a coupling parameter ‘g’. Without Purcell enhancement, which may be very small, within the quantum dot, the exciton's radiative lifetime may be −1 ns. Preferable values of Tₚᵤₗₛₑ are therefore much less than this, for example less than: 500 ps; or 400 ps; or 300 ps; or 200 ps; or 100 ps. The value of Tᵢₙₜ to be more than the exciton's radiative lifetime, for example more than: 2 ns; or 3 ns; or 5 ns; or between 3 ns and 10 ns.

Consequently, production of single photons from the p-i-n junction, and the quantum dot within it, can be regulated through pulsing of pumping/drive pulses for injecting charge carriers into the quantum dot. This leads to a pulsed emission of individual photons from the quantum dot into the optical cavity of the photonic crystal. This is enabled by ensuring that the width of each voltage drive pulse is much less that the exciton lifetime in the quantum dot. This is achieved, as described above, by biasing the p-i-n junction with rectangular voltage pulses, at a desired repetition rate, superimposed upon a flat DC bias voltage positioned just below the threshold voltage which “switches on” the conductivity of the p-i-n junction. The quantum dot is arranged such that the wavelength of a photon emitted by the quantum dot is a wavelength lying within a photonic band gap of the photonic crystal. Consequently, the emitted photon is not able to propagate through the photonic crystal regular structure/array, but is permitted as a light mode of the crystal defects defining the optical cavity and the single-mode waveguide. In this way, by a careful choice of the properties of the optical cavity, the quantum dot, and the pumping/drive pulses applied to the quantum dot by the electronic control unit 3, the single-photon source is able to reliably produce individual photons on demand, for use in quantum key distribution.

A photonic crystal waveguide can be arranged to support a liner state of polarisation in optical modes travelling along it. A photonic crystal waveguide employed in preferred embodiments of the invention, in any aspect, may be arranged to support one desired linear polarisation mode. For example, the photonic crystal waveguide 13 of the single-photon source may be arranged to support a (e.g. one) preferred linear state of polarisation in optical modes guided by it. This waveguide structure may provide the function of the polariser unit 4 illustrated in FIG. 1 schematically. The linear state of polarisation of the photon output by the polariser unit 4 is oriented so that it enters the polarisation rotator unit 5 at substantially 45 degrees to the fast axis of the field-induced birefringence material within the polarisation rotator. Methods for producing polarising photonic crystal waveguides are well known in the art, and a suitable such photonic crystal waveguide structure may be employed in this regard, as would be readily apparent to the skilled person.

FIG. 5 schematically illustrates an example of the polarisation rotator unit 5, previously illustrated schematically in FIG. 1. The polarisation rotator unit comprises a photonic crystal consisting of a regular array of cylindrical dielectric rods 10 of common radius and separated neighbour-to-neighbour by a common separation defined by the lattice constant (‘a’) of the photonic crystal structure. In some embodiments, the material, dimensions structure and arrangement of the dielectric rods 10 is the same as that of the photonic crystal present in the single-photon source 2 described above with reference to FIGS. 2 to 4. Indeed, in some embodiments the photonic crystal structure of the polarisation rotator unit may simply be a continuation of the photonic crystal structure of the single-photon source. In other embodiments, the photonic crystal structure of the single-photon source may be different or separate from the photonic crystal structure of the polarisation rotator unit, such as is illustrated in FIG. 5.

A linear crystal defect 30 extends along the length of the photonic crystal structure of the polarisation rotator unit from one side of the unit to the other side, and comprises the absence of an entire single row of dielectric columns 10 from the otherwise regular array of dielectric columns. In other arrangements, the defect could be comprised of a row of defected columns, for example columns with reduced diameters. This results in provision of a single-mode waveguide. The single-mode waveguide of the polarisation rotator unit extends through the unit from an optical input part (e.g. input port) 32 of the unit which is arranged in optical communication to the optical output part (e.g. output port) of the waveguide of the polarisation rotator, and is thereby arranged to receive individual linearly polarised photons output by the polarisation rotator. The single-mode waveguide 30 extends to an optical output part (e.g. output port) 33 of the polarisation rotator unit for outputting individual photons received by the unit and guided through the unit by the waveguide. The waveguide may be longer than is shown in the figures, which show short structures to aid clarity, and may be longer. It may be comprised of many photonic crystal unit cells in length. This is determined by the amount of birefringence required in conjunction with the applied birefringence-inducing voltage without, causing undue heating to the chip.

A field-induced birefringence material 32 fills the optical waveguide 30, and is arranged to acquire optical birefringence in response to an electrical field applied to the material, selectively. An optically transparent material 18 occupies the space between dielectric rods 10 of the photonic crystal of the polariser unit, other than the volume of the single-mode waveguide therein. The optically transparent material may be itself a birefringent material. The material that fills the regions between the dielectric columns of the photonic crystal, and the waveguide, may be the same material, for ease of manufacture when making an integrated chip including a polarisation rotator as described below, and/or for improved optical performance. A pair of separate and separated birefringence control electrodes (34, 35) are arranged upon, or around, the photonic crystal adjacent the single-mode optical waveguide and the field-induced birefringence material within it.

An aspect of the invention is provision of a “waveplate” (or phase-modulator), such as described above with reference to the polarisation rotators (5, 62). The birefringence material within the optical waveguide formed by the linear photonic crystal defect within these units is responsive to an applied electric field to adopt birefringence. This has the effect of causing the material to acquire and “optic axis” so that birefringence occurs for optical propagation perpendicular to the axis. This imposes a phase difference as between those components (as projected/resolved onto the optical axes of the birefringent material) of the electrical filed vibrations of a propagating linearly polarised photon, given by:

Δϕ=2πΔnt/c

Here, Δn is the difference between refractive indices (‘ordinary/extraordinary’ or ‘slow/fast’); t is the length of the waveguide containing the birefringence material; f is the frequency of light, and c its speed in vacuum. The amount of phase shift is controlled not only by Δn for a given value of t, the length of the waveguide. The field strength applied to the birefringence material is selected, for a given value of t, to achieve the necessary change Δn in refractive index within the waveguide to achieve a desired phase difference Δϕ at the output of the waveguide, and thus, at the output of the waveplate. In this way, a phase difference as between those components (as projected/resolved onto the optical axes of the birefringence material) of the electrical filed vibrations of the output photon, changes the state of polarisation of the photon, in the manner of a waveplate. Thus, by applying an appropriate electric field across the field-induced birefringence material, a phase difference Δϕ can be introduced between the polarisation components (i.e. those resolved onto the fast ad slow axes) to rotate the initial linear state of polarisation of the optical mode (photon) to any linear or circular polarisation states required. The photonic crystal defining the waveguide of the polarisation rotator containing the birefringence material, can be made/arranged to be un-polarising so that the photonic crystal waveguide of the polarisation rotator (e.g. the “waveplate”) should not be sympathetic to any one linear polarisation state over any another. Methods for producing polarising photonic crystal waveguides are well known in the art, and a suitable such photonic crystal waveguide structure may be employed in this regard, as would be readily apparent to the skilled person.

In FIG. 5, there is shown, schematically, an example of an arrangement of separated birefringence control electrodes (34, 35), which places those electrodes at opposite sides of the photonic crystal such that the electric field generated between them extends transversely across the linear axis of the single-mode waveguide 30, and transversely across the cylindrical axes of dielectric columns 10 of the photonic crystal either side of the optical waveguide.

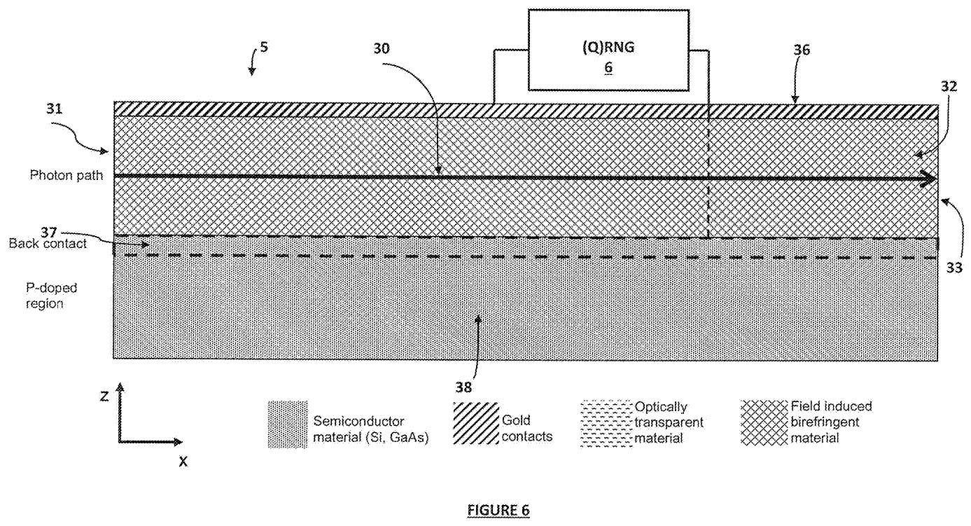

FIG. 6 schematically illustrates an alternative arrangement in which a first birefringence control electrode 36 is arranged to extend along the length of the optical waveguide directly above the linear defect in the photonic crystal defining that waveguide. The first birefringence control electrode 36 is disposed at a surface of the photonic crystal opposite to the substrate 38 from which the dielectric columns of the crystal extend, thereby to sandwich the linear defect in between that electrode and the substrate. A second birefringence control electrode 37 is arranged upon a surface of the substrate at one side of the photonic crystal extending along an outermost row of dielectric columns of the crystal in parallel to the linear axis of the single mode waveguide 30. This arrangement is beneficial in that it reduces the spatial separation between the first and second birefringence control electrodes with the result that a given electric field strength may be generated between them by applying between them a lower potential difference than would be required in the arrangement illustrated in FIG. 5 to electrodes are spaced by a larger spacing. The top electrode may also be beneficial in reflecting any leaked light vertically back to the waveguide, hence reducing the waveguide losses.

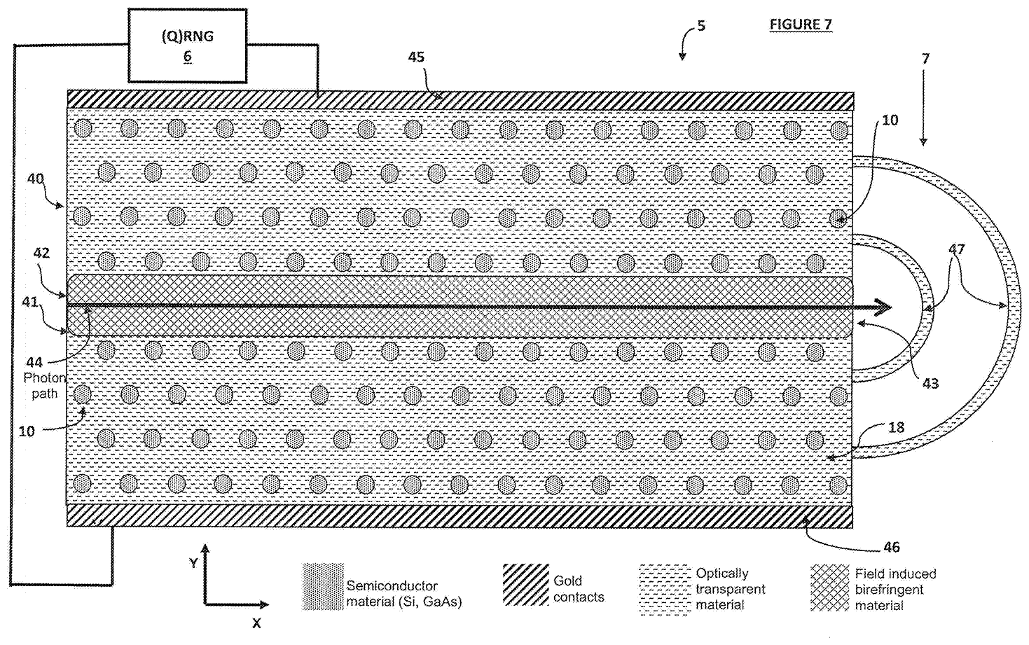

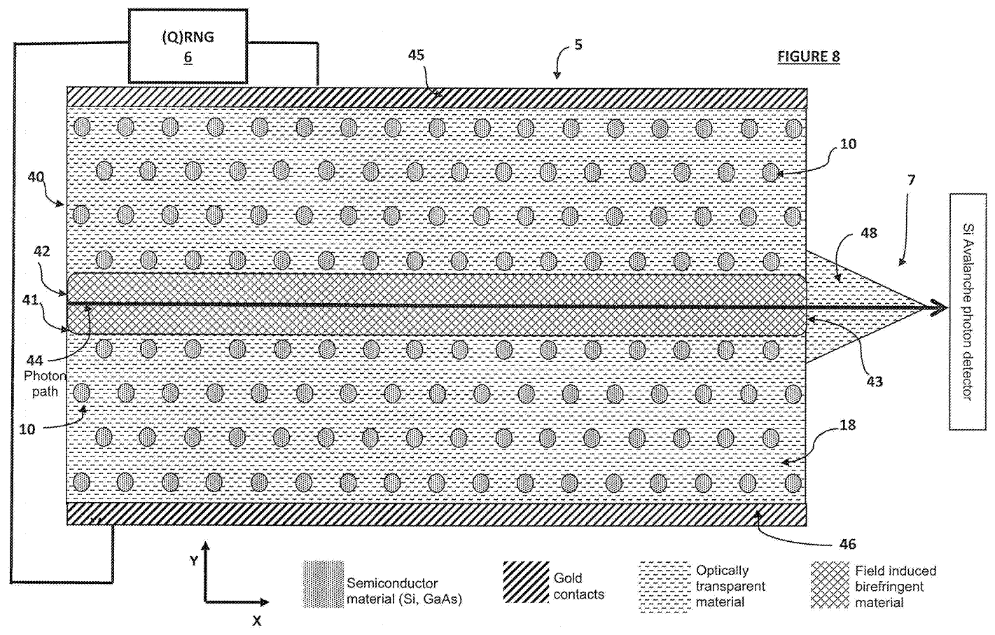

FIGS. 7 and 8 schematically illustrate examples of the polarisation rotator unit 5 of the type described with reference to FIG. 5. The aim of FIGS. 7 and 8 is to illustrate the termination of a polarisation rotator with an optical out-coupler. This applies equally to the polarisation rotator unit of the type described with reference to FIG. 6. FIGS. 7 and 8 schematically illustrate an example of an arrangement of separated birefringence control electrodes (45, 46), which places those electrodes at opposite sides of the photonic crystal 40 such that the electric field generated between them extends transversely across the linear axis of the single-mode waveguide 41, and transversely across the cylindrical axes of dielectric columns 10 of the photonic crystal either side of the optical waveguide.

The quantum random number generator unit 6 is arranged to apply a voltage signal of randomly selected from amongst four predetermined voltage values, between the separated birefringence control electrodes so as to generate an electric field between the electrodes which extends through the field-induced birefringence material, thereby to induce birefringence within the material. The field-induced birefringence material is responsive to the applied electric field to acquire a birefringence, in proportion to the magnitude of the voltage signal question, which acts upon individual photons, when guided through the single-mode waveguide, to rotate the plane of polarisation of the photon in question by an amount in proportion to the magnitude of the electrical field applied to the birefringence material. This may result in a change in linear polarisation or the creation of a circular polarisation, as desired. As a result, the polarisation of the photon is rotated to a state of polarisation (rectilinear; diagonal; circular) which is determined randomly by the randomly-selected magnitude of the voltage signal output from the random number generator. In this way, the polarisation rotator 5 is controllable by the random number generator unit 6 to impose a randomly-selected polarisation state upon photons emitted by the single-photon source, for subsequent transmissions of a quantum cryptographic key according to a suitable QKD protocol, such as the BB84 protocol. The applied rotations are preferably stored in a memory to use later for key sifting.

The optical output part (e.g. output port) 43 of the polarisation rotator is optically coupled to a photon out-coupler 7 which may take the form of a Bragg out-coupler 47, or a convergent wedge out-coupler 48, as illustrated in FIGS. 7 and 8 respectively. In this way, a single-photon, possessing a randomly-selected state of polarisation, is out coupled from the output part (e.g. output port) 43 of the single-mode waveguide 41 for onward transmission to a quantum key distribution receiver apparatus, such as will be described below.

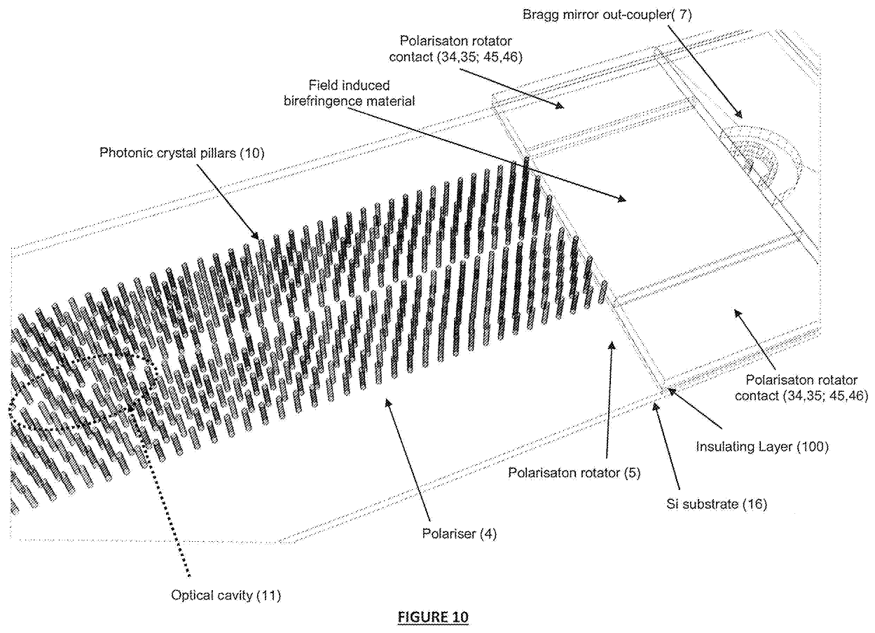

FIG. 9 and FIG. 10 each illustrate an arrangement of key elements of the quantum key distribution transmitter of FIG. 1, in an alternative embodiment. This has the single-photon source 2, polariser 4, polarisation rotator 5 and photon out-coupler 7 integrated onto a common single silicon substrate, as an integrated photonic chip. In the embodiment illustrated in FIG. 9, the single-photon source, polariser and polarisation rotator are all comprised within same single photonic crystal structure which contains the optical cavity of the single-photon source and one continuous linear photonic crystal defect defining a single linear single-mode waveguide employed in the single-photon source, the polariser and the polarisation rotator as described above with reference to preceding figures. A Bragg mirror out-coupler is provided at the terminal output end of the common optical waveguide at the polarisation rotator portion of the single, photonic crystal structure.

In a similar, but alternative, embodiment illustrated in FIG. 10, the polarisation rotator is provided once more by use of a field induced birefringence material, driven by birefringence drive electrodes either side of the birefringence material, disposed upon the silicon substrate of the apparatus. However, the birefringence material of the polarisation rotator is separate from, and is not incorporated within, the photonic crystal, or any single-mode waveguide provided within the photonic crystal, which is otherwise employed in to define the optically coupled proceeding parts of the apparatus such as the single-photon source, and polariser. Whereas a common linear crystal defect within a common photonic crystal structure provides an optical waveguide for guiding individual photons output from the single-photon source of this structure, and onwards through the polariser part of the structure, this photonic crystal structure terminates at the optical output part (e.g. output port) of the polariser, which is optically coupled to the separate birefringence material of the polarisation rotator part of the apparatus.

In the arrangement shown in FIG. 9, a photonic crystal structure comprises a lattice of photonic crystal pillars structured and arranged to define a single-mode waveguide (linear lattice defect) which may be structured and arranged to be generally polarising in those parts of the waveguide serving as a polarising unit 4. The crystal may, therefore, be structured according to techniques readily apparent to the skilled person to support an (e.g. one) optical mode having a desired state of linear polarisation. As such, a first port of the waveguide serves as a polariser 4, as described above. The single-mode waveguide also contains a field-induced birefringence material 32 (not shown, for clarity) and, thus, concurrently serves as the optical waveguide of a polarisation rotator 5, as described above. In this way, the same photonic crystal optical waveguide structure may serve the dual purpose of the polariser unit 4 and the polarisation rotator 5 functionally/schematically illustrated in FIG. 1. The same principle applies to the polarisation rotator 62 and the polariser 63 of the quantum key distribution (QKD) receiver illustrated in FIG. 11, and described below. Polarisation modulator contacts (e.g. gold) extend along the sides of those parts of the photonic crystal optical waveguide used to implement polarisation modulation in the manner described above. Thus, the part serves as an example of a “waveplate”. At those parts of the waveguide, the photonic crystal may be structured and arranged differently from the proceeding parts serving as a polariser, so as to provide substantially no preferential polarisation to optical modes. This avoids interference with the polarisation modulation function of the field-induced birefringence material occupying that part of the waveguide.

In FIG. 10, a field-induced birefringence material is provided as a rectangular slab or sheet of uniform thickness extending over the Si substrate of the device, and having a rectangular side edge abutting the terminal end of the photonic crystal defining the optical polariser 4. The abutting side edge of the filed-induced birefringence material extends along the length of the terminal end of the photonic crystal and is in immediate optical communication with the optical output end (e.g. port) of the waveguide of the photonic crystal defining the polariser 4. There is no photonic crystal waveguide structure within or around the field-induced birefringence material, or any optical out-coupling structure between the waveguide output end (e.g. port) of the photonic crystal waveguide abutting the field-induced birefringence material. The inventors have found that light from optical modes of the waveguide of the photonic crystal is able to enter into the slab/sheet via the surface of its abutting side edge, which has a thickness similar to, or the same as, the height of the photonic crystal pillars adjacent to it where they abut. Polarisation modulator contacts (45, 46) are arranged to receive voltage signals from the quantum random number generator 6 to generate an electrical field across the slab/sheet of field-induced birefringence material to induce optical birefringence therein, as described above. This provides a polarisation rotator 5. Because the polarisation rotator component is butted-up against the optical output end of the waveguide of the polariser unit 4, light output from it must enter the polarisation rotator. Although a portion of the output may be reflected from the interface (i.e. slab edge), this has been found to be a negligible loss.

The slab of field-induced birefringence material is preferably selected to have a sufficiently large refractive index to support total internal reflection (TIR) and thereby act as a slab waveguide in its own right. Because if this, a photonic crystal waveguide structure for guiding light through the field-induced birefringence material, may be dispensed with in such embodiments. Whereas the arrangement of FIG. 10 might incur slightly greater optical losses as compared to other embodiments (e.g. FIG. 9), the relative simplicity of manufacture and implementation of the structure may compensate for this. The same principle applies to the polarisation rotator 62 and the polariser 63 of the QKD receiver illustrated in FIG. 11, and described below.

FIG. 11 schematically illustrates a quantum key distribution receiver apparatus 60 according to a preferred embodiment of the invention. This receiver apparatus is adapted and arranged for receiving individual photons transmitted from a quantum key distribution transmitter apparatus, such as the transmitter apparatus of FIG. 1. The receiver apparatus 60 comprises a photon in-coupler 61 arranged to receive individual photons transmitted to the receiver apparatus and to couple the photons into an optical transmission channel within the receiver apparatus for communicating the received photon through the receiver apparatus for processing, as will be described below. This inward transmission to the receiver may be an inward transmission conducted via any suitable optical transmission medium or mechanism, such as a fibre-optic medium, or may be free-space transmission, by which the receiver apparatus may be adapted to receive photons.

The photon in-coupler is arranged in optical communication with a polarisation rotator unit 62. Accordingly, an optical output part (e.g. output port) of the photon in-coupler is raised in optical communication with an optical input part (e.g. input port) of the polarisation rotator unit. The polarisation rotator unit is arranged to impose a pre-selected rotation to the state of polarisation of individual photons received by it. Polarisation-rotated individual photons are subsequently directed to an optical output part (e.g. output port) of the polarisation rotator 62 to an optical input part (e.g. input port) of an optical polarisation unit 63 arranged to receive the polarisation-rotated individual photons output from the polarisation rotator, and to impose a predetermined state of linear polarisation upon those received photons. An optical output part (e.g. output port) of the polariser 63 is arranging optical communication with an optical input part (e.g. input port) of a single-photon detector unit 64 such that polarised individual photons output from the polariser are received into an optical path of the single-photodetector for detection therein.

An electronic control unit 65 is arranged in command communication with both the single-photon detector 64 and the quantum random number generator 66, and is arranged to issue respective electrical control signals to both, separately and in synchrony. In particular, electrical control signals issued from the electronic control unit to the quantum random number generator, are arranged to control the quantum random number generator to issue a voltage signal to the polarisation rotator to cause it to impose a polarisation state upon single photons received from the in-coupler. Similarly, electrical control signals issued in synchrony with this, from the electronic control unit to the single-photon detector 64 place the single-photon detector in a detecting state suitable for detecting a single-photon when received from the polariser 63. The polariser unit 63 is substantially as described above, in any embodiment, with reference to the polariser unit 4 of the quantum key distribution transmitter system illustrated in FIG. 1. In particular, the polariser is arranged to impose a predetermined state of polarisation on photons received by it from the polarisation rotator, for onward transmission to the single-photon detector 64.

The quantum random number generator unit 66 may be substantially as described above with reference to the quantum random number generator unit 6 of FIG. 1, in any embodiment. It is arranged to apply between the separated birefringence control electrodes a voltage signal of magnitude randomly selected so as to generate an electric field between the electrodes which extends through the field-induced birefringence material, thereby to induce birefringence within the material. The field-induced birefringence material is responsive to the applied electric field to acquire a birefringence, in proportion to the magnitude of the voltage signal question, which acts upon individual photons, when guided through the single-mode waveguide, to rotate the polarisation of the photon in question by an amount in proportion to the magnitude of the electrical field applied to the birefringence material. This may result in a change in linear/circular polarisation or the creation of a circular/linear polarisation, as desired. As a result, the polarisation of the photon is rotated to a state of polarisation (rectilinear; diagonal; circular) which is determined randomly by the randomly-selected magnitude of the voltage signal output from the random number generator. In this way, the polarisation rotator is controllable by the random number generator unit 66 to impose a randomly-selected polarisation state upon photons it receives, as part of a quantum cryptographic key according to a suitable QKD protocol, such as the BB84 protocol.

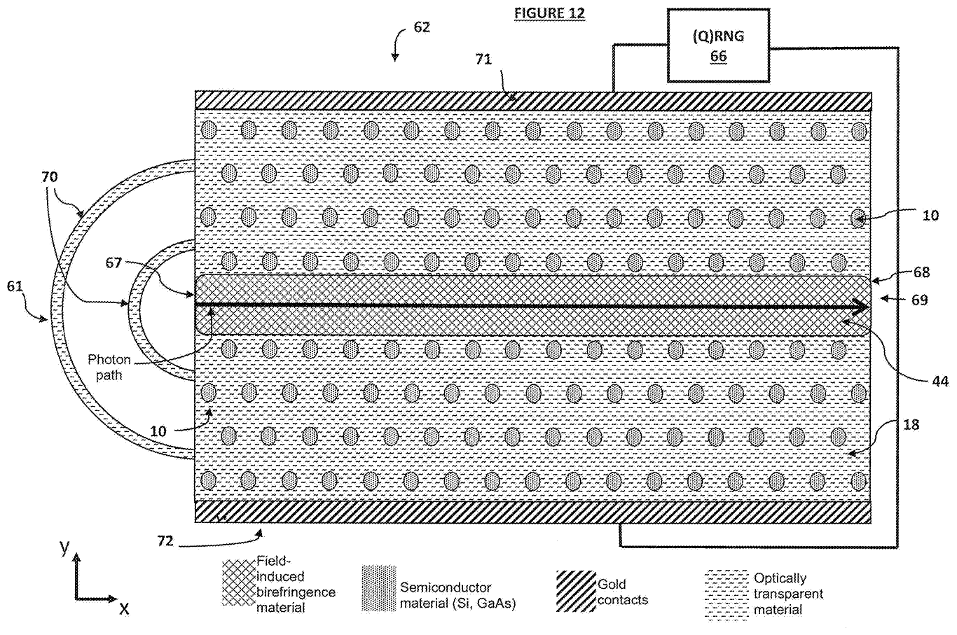

FIG. 12 schematically illustrates an example of the photon in-coupler 61 and the polarisation rotator unit 62, previously illustrated schematically in FIG. 11. The polarisation rotator unit comprises a photonic crystal consisting of a regular array of cylindrical dielectric rods 10 of common radius and separated neighbour-to-neighbour by a common separation defined by the lattice constant (‘a’) of the photonic crystal structure. In some embodiments, the material, dimensions structure and arrangement of the dielectric rods 10 as described above with respect to the photonic crystal present in the quantum key distribution transmitter unit 1, such as the polarisation rotator unit 5 described above with reference to FIGS. 7 to 8, and/or the photonic crystal structure present within the polariser unit 4. Indeed, since/if the QKD receiver is to be used to receive from the QKD transmitter described herein, then the wavelength of photons are expected to be the same as between transmitted and receiver. Consequently, the optical characteristics of the QKD receiver are sympathetic to, or coordinated with (e.g. the same as) those of the QKD transmitter.

A linear crystal defect 68 extends along the length of the photonic crystal structure of the polarisation rotator unit 62 from one side of the unit to the other side, and comprises the absence of a row of dielectric columns 10 from the otherwise regular array of dielectric columns. This results in the provision of a single-mode waveguide, in the manner described above with reference to the single-mode waveguide 13 of the single-photon source 2 of the quantum key distribution transmitter system 1. In extending through the photonic crystal of this unit, the single-mode waveguide of the polarisation rotator unit extends through the unit from an optical input part (e.g. input port) 67 of the unit which is arranged in optical communication with the photon in-coupler 61, to receive individual polarised photons received from the quantum key distribution transmitter unit. The single-mode waveguide 68 extends to an optical output part (e.g. output port) 69 of the polarisation rotator unit for outputting individual polarised photons received by the unit and guided through the unit by the waveguide.

A field-induced birefringence material 44 fills the optical waveguide 68, and is arranged to acquire optical birefringence in response to an electrical field applied to the material, selectively. An optically transparent material 18 occupies the space between dielectric rods 10 of the photonic crystal of the polarisation rotator unit, other than the volume of the single-mode waveguide therein. A pair of separate and separated birefringence control electrodes (71, 72) are arranged upon, or around, the photonic crystal adjacent the single-mode optical waveguide and the field-induced birefringence material within it. The quantum random number generator unit 66 is arranged to apply a voltage signal of randomly selected from amongst four predetermined voltage values, between the separated birefringence control electrodes so as to generate an electric field between the electrodes which extends through the field-induced birefringence material, thereby to induce birefringence within the material. The field-induced birefringence material is responsive to the applied electric field to acquire a birefringence, in proportion to the magnitude of the voltage signal question, which acts upon individual photons, when guided through the single-mode waveguide, to rotate the polarisation of the photon in question by an amount in proportion to the magnitude of the electrical field applied to the birefringence material. As a result, the polarisation of the photon is rotated to a state of polarisation (linear or circular) which is determined randomly by the randomly-selected magnitude of the voltage signal output from the random number generator. In this way, the polarisation rotator 62 is controllable by the random number generator unit 66 to impose a randomly-selected linear polarisation orientation upon photons emitted by the single-photon source, for subsequent processing for generation of a quantum cryptographic key according to a suitable QKD protocol, such as the BB84 protocol.

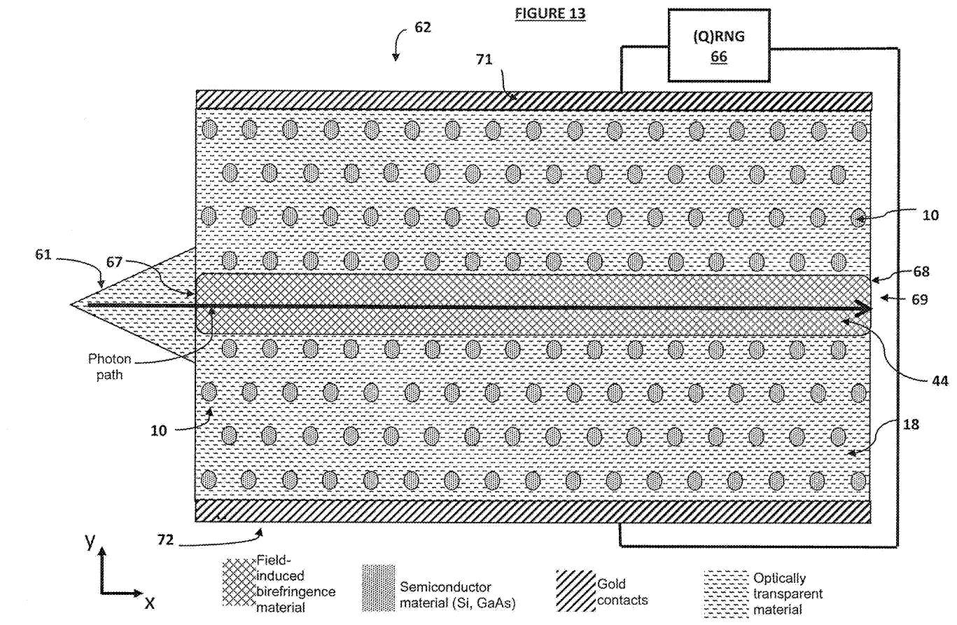

The optical input part (e.g. input port) 67 of the polarisation rotator 62 is optically coupled to an optical output part (e.g. output port) of the photon in-coupler 61, which may take the form of a Bragg out-coupler 70, or a convergent wedge out-coupler as illustrated in FIGS. 12 and 13, respectively. In this way, a single-photon transmitted from the quantum key distribution transmitter unit one, and possessing a linear polarisation oriented in a randomly-selected plane of polarisation, may be in-coupled to the single-mode waveguide 68 for processing by the quantum key distribution receiver apparatus, such as will be described below.

FIGS. 12 and 13 schematically illustrate an example of an arrangement of separated birefringence control electrodes (71, 72), which places those electrodes at opposite sides of the photonic crystal of the polarisation rotator, such that the electric field generated between them extends transversely across the linear axis of the single-mode waveguide 68, and transversely across the cylindrical axes of dielectric columns 10 of the photonic crystal either side of the optical waveguide. In other embodiments, one of these two birefringence control electrodes may be placed directly over the waveguide 68 so as to extend along its linear axis in close proximity to the birefringence material 44 contained within the waveguide. This has the benefit of reducing the separation between the two separated birefringence control electrodes thereby reducing the magnitude of the potential difference/voltage required to be applied between them in order to exert a given magnitude of electric field upon the birefringence material 44.

An optical output part (e.g. output port) of the polarisation rotator unit 62 is arranged in optical communication with an optical input part (e.g. input port) of the polariser unit 63 of the receiver apparatus 60. The polarising unit 63 comprises a polariser of the same structure, design and arrangement as the polariser unit 4 of the quantum key distribution transmitter unit 1, illustrated and described with reference to FIG. 1. The reader is referred to the structure and functionality of the polariser unit 4 of FIG. 1.

Whereas the polarisation rotator 62, the polariser unit 63, and the single-photon detector 64 schematically presented, in FIG. 11, as separate units in optical communication, in other embodiments of this invention, those units may be formed integrally as a single continuous receiver unit. Indeed, in some embodiments the photonic crystal structure of the polarisation rotator 62, the polariser unit 63, and the single-photon detector 64 may simply be parts of one continuous photonic crystal structure. In other embodiments, the photonic crystal structure of the polariser unit 63 may be separate from the photonic crystal structure of the polarisation rotator unit 62, and/or of the single-photon detector 64.

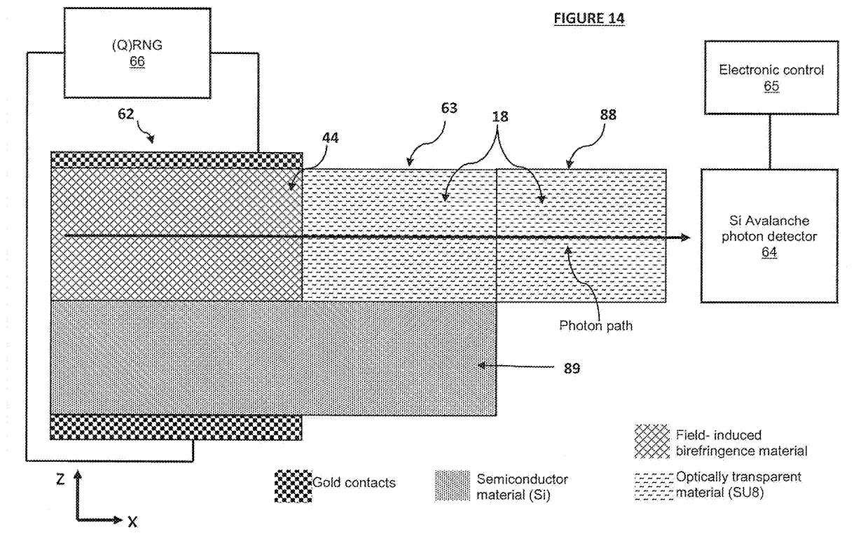

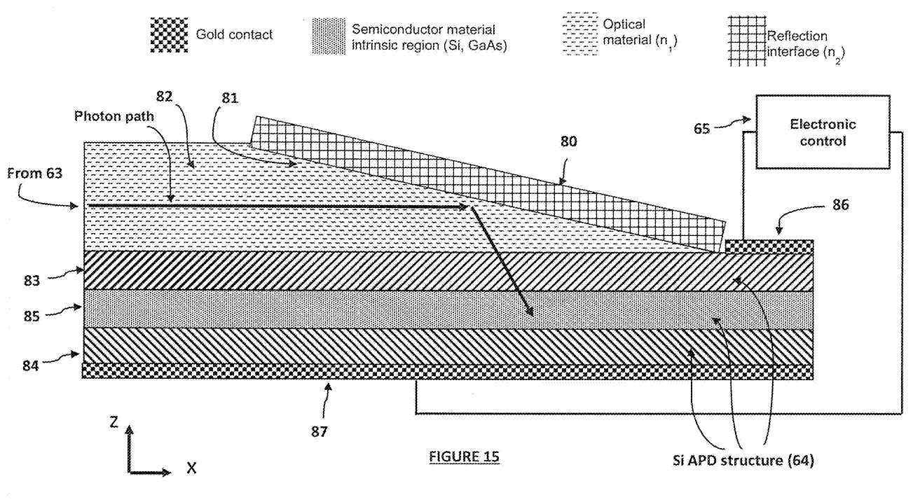

The optical output part (e.g. output port) of the polarising unit 63 is arranged in optical communication with an optical input part (e.g. input port) of the single-photon detector 64 of the receiver apparatus. Accordingly, polarised individual photons are directed from the polariser unit 63 for input into the single-photon detector unit 64 for detection. FIG. 14 and FIG. 15 show to alternative embodiments of a single-photon detector unit 64.

Referring to FIG. 14, the single-photon detector comprises a silicon-based avalanche photodiode detector unit optically coupled to the optical output part (e.g. output port) of the polarising unit 63 by a wedge-shaped out-coupler 88 which is arranged to direct individual photons out from the single-mode waveguide of the polarising unit 63 and into the photosensitive detection region of the silicon avalanche photodiode single-photon detector 64 which is in signal communication with the electronic control unit 65. In this arrangement, the silicon-based avalanche photodiode unit is aligned with, but separate from, the structure of the polariser unit, and is merely optically coupled to the structure of the polarising unit via the out-coupler wedge 88. The optically transparent material 18 contained within the optical waveguide of the polarising unit 63 and forming the out-coupler wedge, may be any suitable optical material, such as SU8, as is readily available to the skilled person. Other optical materials may be used. The silicon substrate 89 is shown in cross section in the z-x plane containing the axis of the optical waveguide passing through the polarisation rotator 62 and the polariser unit 63, and therefore does not show the photonic crystal columns extending from the substrate.

Contrast this with the embodiment illustrated in FIG. 15, in which the compound semiconductor structure of the silicon avalanche photodiode is integrally formed with the structure of the polariser unit 63 collectively forming parts of a photonic chip. In particular, the compound semiconductor structure of the avalanche photodiode 64 comprises a p-i-n semiconductor layer consisting of a layer 83 of p-doped silicon semiconductor material grown upon a layer 85 of intrinsic silicon semiconductor material which is, in turn, grown upon a substrate layer of n-doped silicon semiconductor material 84. Most notably, cylindrical columns 10 of the photonic crystal lattice structure of the polarising unit 63 are, in turn, grown upon the upper surface of the layer 83 of p-doped silicon semiconductor material, so as to form a single-mode waveguide 82 for guiding individual photons to the avalanche photodiode structure 64 underlying the waveguide. The photonic crystal is not drawn in FIG. 14, to aid clarity. In this way, the silicon-based avalanche photodiode structure 64, and the photonic crystal structure of the polarising unit 63 are integrally formed as successive semiconductor materials, grown one upon the other, to form a single unit. This single unit may be grown using known epitaxial growth techniques.

In alternative embodiments, embodying this principle of integrated growth, the single-mode waveguide 82 of the single-photon detector may be a structure other than a linear defect in a photonic crystal, and may take structural form of any other waveguide structure suitable for guiding individual photons for detection by the avalanche photodiode structure underlying it.

The electronic control unit 65 of the quantum key distribution receiver unit, 60, is arranged in electrical contact with a pair of electrical biasing terminals (86, 87) of which first biasing terminal 86 is arranged in electrical contact upon an outer surface part of the layer 83 of p-doped silicon material of the avalanche photodiode. Similarly, a second biasing terminal 87 is arranged upon the opposite outer surface of the substrate layer of n-doped silicon semiconductor material. This arrangement of electrical biasing terminals allows a bias voltage, generated by the electronic control unit 65, to be applied across the p-i-n compound semiconductor structure of the avalanche photodiode. When an individual photon is received into the single-photon detector 64, from the polariser unit 63 optically coupled to it, that photon is guided along the waveguide portion 82 of the detector towards an oblique reflective interface 81 which reflects the photon towards the layer of p-doped silicon 83 underlying the waveguide 82, in the direction generally transverse to the plane of the p-doped layer. The reflected photon thereby enters the p-i-n structure, and passes through the p-doped layer 83 so as to enter the intrinsic semiconductor layer 85 where it may interact with the semiconductor material and induce an avalanche event enabling the individual photon to be detected electrically, in the manner of an avalanche photodiode detection as would be readily apparent to the skilled person.

The oblique reflective interface 81 is provided by a planar layer of material 80 disposed across the transmission axis of the waveguide structure 82 of the single-photon detector so as to present an oblique planar interface towards the optical input part (e.g. input port) of the single-photon detector, and simultaneously towards the opposing outward face of the p-doped layer 83 of the p-i-n semiconductor structure. The notional normal to the surface of the reflective interface and the transmission axis of the optical waveguide 82 defined a notional plane (in space) which contains the notional normal to the outward surface of the p-doped layer 83 facing the reflective interface 81. This special orientation, and configuration, ensures that when the single-photon is guided along the axis of the optical waveguide 82, and subsequently reflects from the oblique reflective interface 81, it is directed in a direction towards, and substantially perpendicular to, the p-doped layer 83 of the avalanche photodiode. The oblique reflective interface 81 is formed by/at a high contrast in refractive index as between the refractive index of the material forming the optical waveguide 82 of the single-photon detector, as compared to the refractive index of the material forming the oblique planar layer of material 80 disposed across the transmission axis of the waveguide. The refractive index of the material of the oblique planar layer may be suitably significantly higher than, or alternatively may be suitably significantly lower than, the refractive index of the material forming the optical waveguide 82. Both situations will provide an interface with high refractive index contrast which, consequently, will be reflective.

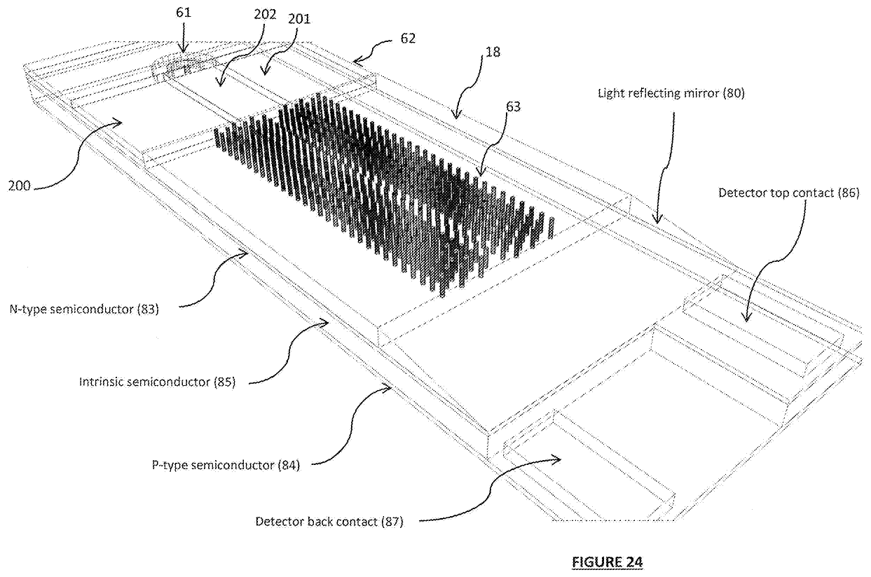

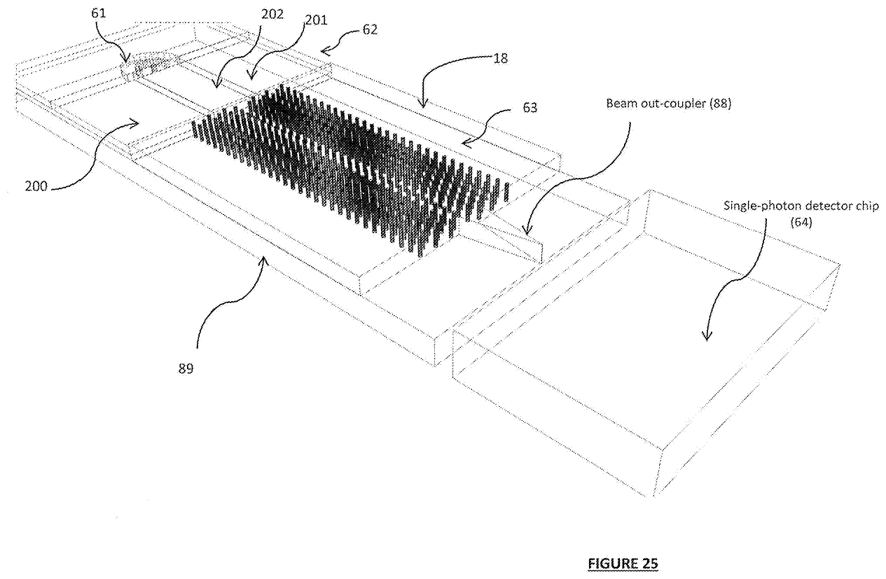

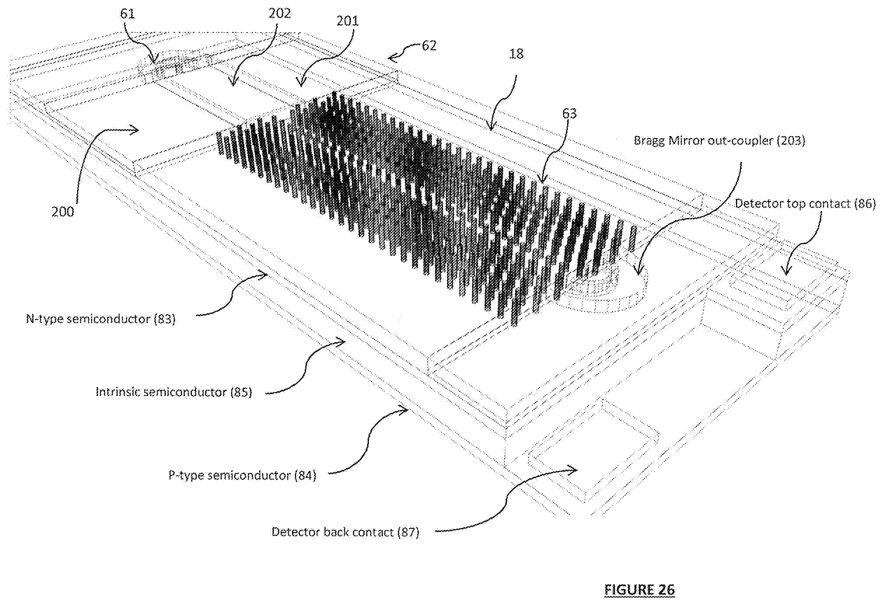

FIG. 24 illustrates an example of the quantum key distribution receiver system as an integrated slab optical waveguide, in which an avalanche photodiode structure is integrated with the slab optical waveguide, and optically coupled to it via a planar reflective surface, or mirror optical out-coupler 80. FIG. 25 illustrates an example of the quantum key distribution receiver system as an integrated slab optical waveguide in which an avalanche photodiode structure separate from the slab optical waveguide, and optically coupled to it via the wedge-shaped beam optical out-coupler 88. FIG. 26 illustrates an example of the quantum key distribution receiver system as an integrated slab optical waveguide in which an avalanche photodiode structure is integrated with the slab optical waveguide, and optically coupled to it via a Bragg mirror optical out-coupler. Each of these three examples incorporate a photonic crystal structure 62 comprising a lattice of photonic crystal pillars structured and arranged to define a single-mode waveguide (linear lattice defect) which supports an (e.g. one) optical mode having a desired state of linear polarisation. As such, the waveguide serves as a polariser 63, as described above with reference to FIG. 11. The self-same single-mode waveguide also contains an optically transparent material 18. A field-induced birefringence material to 202 is provided as a rectangular slab or sheet of uniform thickness and having a rectangular side edge abutting an optical input end of the photonic crystal defining the optical polariser. The abutting side edge of the field-induced birefringence material extends along the length of the optical input end of the photonic crystal and is in immediate optical communication with the optical input end (e.g. port) of the waveguide of the photonic crystal defining the polariser 63. There is no photonic crystal waveguide structure within or around the field-induced birefringence material, or any optical out-coupling structure between the waveguide input end (e.g. port) of the photonic crystal waveguide abutting the field-induced birefringence material. The inventors have found that light from the birefringence material to 202 is able to enter the waveguide of the photonic crystal from the slab/sheet via the surface of its abutting side edge, which has a thickness similar to, or the same as, the height of the photonic crystal pillars adjacent to it where they abut. Polarisation modulator contacts (200, 201) are arranged along opposite side edges of the rectangular slab coplanar with the slab, thereby bounding the field-induced birefringence material between them. The polarisation modulator contacts are arranged to receive voltage signals from the quantum random number generator 66 to generate an electrical field across the slab/sheet of field-induced birefringence material to induce optical birefringence therein, as described above. This provides a polarisation rotator 62. Because the polarisation rotator component is butted-up against the optical input end of the waveguide of the polariser unit 63, light output from it must enter the polariser unit. Although a portion of the light may be reflected from the interface (i.e. slab edge), this has been found to be a negligible loss.

The slab of field-induced birefringence material is preferably selected to have a sufficiently large refractive index to support total internal reflection (TIR) and thereby act as a slab waveguide in its own right. Because if this, a photonic crystal waveguide structure for guiding light through the field-induced birefringence material, may be dispensed with in such embodiments. Whereas the arrangement of FIGS. 24 to 26 might incur slightly greater optical losses as compared to other embodiments, the relative simplicity of manufacture and implementation of the structure may compensate for this.

It is to be noted, in particular, that the arrangements shown in FIGS. 24, 25 and 26 have the optical in-coupler 61, the polarisation rotator 62, and the polariser 63 all arranged in a common plane integrally as a slab optical waveguide. In FIGS. 24 and 26, this slab optical waveguide is formed as a layer upon a contiguous layered structure defining a slab-like p-i-n avalanche photodiode structure. The optical out-coupler of the optical slab waveguide (e.g. a Bragg mirror, or a planar mirror, or optically reflective boundary) optically couples the optical slab waveguide to the slab avalanche photodiode structure, while simultaneously the slab avalanche photodiode structure provides the substrate upon which the components of the slab optical waveguide may be formed (e.g. grown epitaxially or otherwise deposited thereupon). This arrangement is especially sympathetic to the application of well-established manufacturing methods and processes employed in the semiconductor electronics industry, for manufacturing layered semiconductor structures.

FIG. 16 illustrates an alternative embodiment of the elements of a single-photon optical transmitter, employing a photonic crystal, in which photonic crystal structure illustrated in FIG. 9 comprising pillars, is instead provided by a photonic crystal structure comprising a slab containing a lattice structure of holes collectively defining an optical cavity and a waveguide to a Bragg mirror out-coupler. FIG. 17 shows a magnified view of the output end of the photonic crystal waveguide of FIG. 16, and the Bragg mirror out-coupler at that end.

In these structures the inventors have been able to achieve better ‘natural’ confinement in the z-direction (transverse to the plane of the crystal), and therefore there is less/no need to place an optical layer on top of the photonic crystal slab in the manner one might otherwise contemplate when using a photonic crystal formed from an array of dielectric columns. However, a photonic crystal formed from an array of dielectric columns are found to be more robust (e.g. less fragile) and more versatile.

Furthermore, it is not necessary to ensure that there is only one quantum dot located within the optical cavity of a photonic crystal formed from a slab of holes. According to preferred embodiments, the electronic control unit (3; FIG. 11) may be arranged to limit the applied current used to drive the (multiple) quantum dots within the optical cavity so that the average photon number output by the cavity, at any instant, is less than one (1), and so that and the two-photon output probability is sufficiently low. This ensures that even when multiple quantum dots are present within the optical cavity or the photonic crystal, the single-photon source can operate to output photons one-at-a-time. Alternatively, one may simply test individual devices manufactured according to methods described herein, or otherwise, to identify and select only those containing a single quantum dot within the optical cavity of the photonic crystal.

In yet a further possibility, the electronic control unit 3, may be arranged to control the drive voltage to be a drive voltage coincident with a current resonance in the collective current-voltage characteristic of the multiple quantum dots, collectively, such that the resonance corresponds with only the confined exciton in an excited quantum dot having the lowest-energy from amongst the plurality of quantum dots. In this way, the drive voltage may be controlled to excite only one quantum dot within the optical cavity, from amongst a plurality of quantum dots present. Thus, a step of calibrating the electronic control unit 3 may be performed, by investigating/sweeping the current-voltage characteristic of the multiple quantum dots collectively to identify the voltage position/value of a suitable resonance therein. The presence of quantum dots within the rest of the structure of the photonic crystal is not relevant as these other quantum dots are not driven/excited by the electronic control unit. They are also not placed within, or exposed to, the current path applied to the central dielectric column within the optical cavity of the photonic crystal, and the probability of them absorbing a photon as it travels down a subsequent photonic crystal waveguide has been found to be negligibly low because the exciton volume is negligibly low. Consequently, the structural properties of the apparatus lend themselves well to simpler, and cheaper, manufacturing processes well established in the separate field of semiconductor electronics manufacture, without compromising on the optical performance of the apparatus.

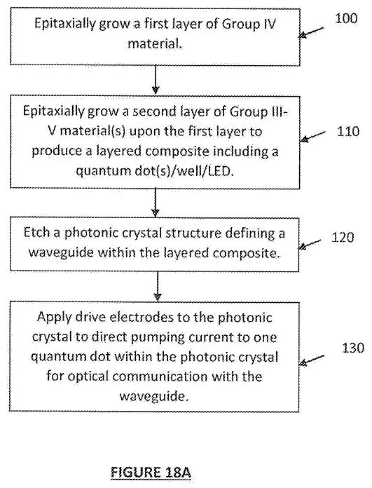

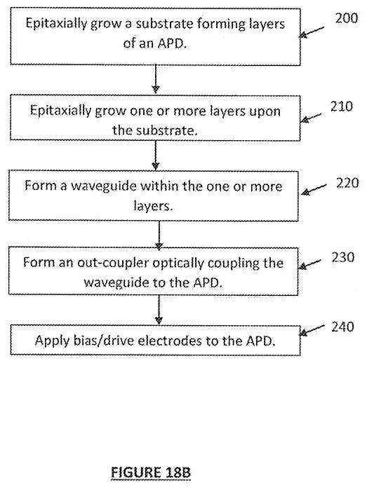

FIG. 18A illustrates a flow-diagram of steps in a sequence of process steps for manufacturing a photonic crystal chip defining a single-photon light source, by a process of epitaxy. The method enables the manufacture of a photonic crystal integrated chip. A first step 100 comprises epitaxially growing a silicon (Si) layer. This layer is formed from a group IV semiconductor which is an indirect-gap single crystal semiconductor material. The second step 110 comprises epitaxially growing a second layer of GaAs directly upon the Si substrate. GaAs is a direct-gap single crystal semiconductor material. The step of growing the first layer and the step of growing the second layer are successive growth stages performed preferably as successive, continuous parts of an epitaxial growth procedure or operation.

The second layer is grown as a layered structure itself, and comprises a first sub-layer of n-doped GaAs, which is grown directly upon the surface of the Si of the first layer, followed by an un-doped second sub-layer of intrinsic GaAs grown upon the surface of the first sub-layer. During the growth of the second sub-layer, the process of growth of the intrinsic GaAs material is interrupted, and temporarily replaced by a process of growth of a plurality of quantum dots upon the exposed surface of the intrinsic GaAs material. Once sufficient quantum dots are provided, per unit area of the exposed surface, the process of growth of the intrinsic GaAs material is resumed thereby to bury/embed/encase the quantum dots within the intrinsic GaAs semiconductor material, and complete the formation of the second sub-layer. This is then followed by the growth of a third sub-layer of p-doped GaAs, which is grown directly upon the surface of the completed second sub-layer. The process of manufacture of the photonic crystal chip then continues with a third step 120 in which the epitaxially grown, layered semiconductor structure provided by the preceding process steps is etched to form a photonic crystal structure comprising a linear crystal defect defining a single-mode optical waveguide, and preferably also comprising a point defect defining an optical cavity e.g. when a single-photon source is being manufactured, within the photonic crystal structure. In particular, the process of etching is implemented upon the second layer consisting of the three gallium arsenide (GaAs) sub-layers described above. In preferred embodiments, the etching process is selected and arranged to define a triangular lattice of upright, linear circular cylindrical dielectric rods 10 as shown in FIG. 2 to FIG. 4. The same process may also be employed to manufacture photonic crystal chips defining optical waveguides used for the polariser units and polarisation rotator as described above. In alternative embodiments, the etching process may define a series of cylindrical holes such as is illustrated in FIG. 16 and FIG. 17. During this etching process, and photon out-coupler 7 and/or the photon in-coupler 61 of FIG. 11 (e.g. a Bragg mirror, or wedge) may also be formed.

When this process is used to form the single-photon source of FIGS. 2, 3 and 4, a subsequent processing step includes applying a conductive drive electrode 22 to the exposed upper end of the thin dielectric rod 12 disposed within the optical cavity 11 of the photonic crystal, and also applying a conductive drive electrode 17 to a surface of the silicon substrate 16 adjacent the photonic crystal array of rods 10. As discussed above, the optical cavity 11 formed by this etching process is in optical communication with the single-mode optical waveguide produced by the same etching process, the two being separated by one (or two) dielectric rods 10 of the photonic crystal structure.

As discussed above, while it may be advantageous, serendipitously to achieve the presence of only one quantum dot within the dielectric rod centred within the optical cavity 11, it is not necessary to achieve the performance and benefits of the invention. As discussed above, one may accept a plurality of quantum dots within the dielectric column, and then tune the voltage applied to the dielectric column so as to resonantly drive only one quantum dot from amongst the plurality. Alternatively, or additionally, one may employ a patterned substrate to control the position of quantum dots during deposition, so as to align them to the intended position of the optical cavity to be formed by subsequent etching of the layered structure containing the deposited layer of quantum dos.

Molecular beam epitaxy, or chemical vapour deposition, may be used to deposit successive layers of the layered structure. Epitaxy refers to the growth of a single crystal film on top of the crystal substrate. Hetero-epitaxy refers to the situation where the film and substrate are different semiconductor compounds (e.g. AlAs grown upon GaAs). In preferred embodiments of the present invention, hetero-epitaxy is employed to create a photonic or optoelectronic structure using a type III-V semiconductor grown upon a type IV semiconductor. The act of trying to grow a layer of different material on top of a substrate will lead to un-matched lattice parameters as between the two materials, at their interface. This will cause strained or relaxed growth of the film upon the substrate, which can lead to inter-facial defects. This typically changes the thermal and electronic properties of the film, and is widely regarded in the field of electronic semiconductor thin films, as a very significant obstacle to device manufacture. For example, electron scattering from inter-facial defects can effectively ruin the required electronic properties of electronic devices, and as such, the growth of a type III-V semiconductor upon a type IV semiconductor, is typically shunned. However, the inventors have found that this prejudice can be safely ignored in the manufacture of a layered photonic device. This is because it has been found that inter-facial defects of the type problematical to micro-electronic performance are not problematical to photonic performance.

Most compound semiconductors are from the III-IV group of materials. Other semiconductors, such as silicon and germanium, are from the group IV elements as follows:

| III | IV | V |
|---|---|---|
| B | C | N |
| Al | Si | P |
| Ga | Ge | As |
| In | Sn | Sb |

Elements for the compound semiconductor materials employed in the present invention may be selected from this table, as appropriate. Examples include: GaAs; InP; GaN; AlN. Optical absorption or emission from semiconductors requires energy and momentum conservation. While the energy of the emitted or absorbed photon can come from the excited electron returning to its ground state (or vice versa), such a transition may require extra momentum which the photon cannot supply. Semiconductor materials that require extra momentum are so-called “indirect-gap semiconductors” and examples include type IV semiconductors. Conversely, semiconductors that do not require electrons to acquire such extra momentum are the so-called “direct-gap semiconductors”. These can emit and absorb photons efficiently. Examples include the III-V group of semiconductors.

While silicon is not the ideal substrate for epitaxy from an electronic point of view, its abundance and ease of processing have made it to the backbone of the semiconductor industry. However, it is a severe lattice mismatch to many type III-V materials, including their direct growth on silicon (or germanium) substrates for electronics use. Instead, wafer bonding processes are used in the art, in which the type III-V layer is grown on a lattice-matched substrate and then bonded to the surface of a silicon wafer using heat and pressure. However, this process is time-consuming, costly and inefficient. It is also is prone to ingress of contaminants in the bonding interface. In preferred embodiments of the present invention, type III-V materials are, nevertheless, epitaxially grown directly from a type IV substrate, such as silicon or germanium. The epitaxial growth processes may be performed using well-known techniques of molecular beam epitaxy, or chemical vapour deposition, with a target substrate housed in a low-pressure environment (of the order 10⁻¹⁰ Torr). Beams of evaporated material may be directed to the target substrate so as to form a film of the material upon it. To achieve epitaxial growth, the surface diffusion of the target substrate is preferably less than the deposition time of the layer being deposited. Both semiconductor material sources and dopant material sources may be arranged around the target substrate, within a low-pressure environment, with each source, and the substrate, being individually heated to generate atomic/molecular beams from the respective source. Shutters may control the exposure to each of the source species so that the appropriate sequence of species are deposited on the target substrate to achieve the desired layered structure.

In preferred embodiments, a silicon (or germanium) substrate may initially have grown upon it a type III-V buffer layer (e.g. AlAs) which may have minimal thickness of between 5 nm and 50 nm, for example. A subsequent series of layers of type III-V material may then be grown in succession upon the top of the buffer layer as desired to form a layered structure on top of the silicon (or germanium) substrate. This layered structure may include the p-i-n layering described above, in which quantum dots are incorporated in the intrinsic semiconductor component of the p-i-n layering. The layered structure may subsequently be etched to form a photonic crystal structure comprising suitable crystal defects such as to form an optical cavity e.g. for a single-photon source and/or an optical waveguide e.g. in a single-photon source, a polarising unit, and/or a polarisation rotator, as required at the desired location in the layered structure. Similarly, optical out-coupler and/or in-coupler structures may also be etched into the layered structure as desired e.g. Bragg grating structures, Bragg mirror structures. Desired materials may be deposited within the empty portions or gaps formed by the etching process, such as optically transparent material within the photonic crystal structure or Bragg grating/mirror structures, or field-induced birefringence material or field-induced variable index (refractive index) material within optical waveguide structures. Overlaying structures may then be deposited upon the etched, and optionally filled, structures formed in the layered structure, so as to provide optical confinement functions, as described above, and/or to provide electrical contacts. For example, metallic contacts (e.g. gold) may be deposited as strips, plates or layers along the side and/or upon or over desired parts of the etched and layered structure. Examples include: electrical contact plates adjacent a photonic crystal lattice for supporting an electrical field in a polarisation rotator, such as described above; and/or electrical contacts upon and adjacent a photonic crystal lattice for supporting an electrical drive current through a quantum dot located in an optical cavity of a single-photon source, such as described above; and/or electrical contacts for supporting a bias voltage to be applied across a p-i-n structure of an avalanche photodiode, such as described herein.

A suitable procedure of growing the quantum dots would be any one of the following: the well-known Stranski-Kranstanov procedure; the well-known Droplet Epitaxy procedure; Other suitable procedure as would be readily apparent to the skilled person. The different component semiconductor arrangements suitable for the quantum dot, are as described above. Examples include InAs and GaSb, and in particular, GaSb has an advantage in being optically active at room temperature.

A dry etching method, such as reactive-ion etching, may be employed to etch structures (e.g. photonic crystal structures; Bragg mirrors etc.) into the layers of the layered structure formed by the preceding growth steps, described above. The dielectric columns of the photonic crystals may be other than circular cylindrical. Other, different cylindrical geometries for the columns would be acceptable. However, square cylinders, or other cylinder shapes, are more difficult to manufacture/process, and it has been found that cylinders of a circular cross-section is the easiest to manufacture reliably with sufficient quality.

The nature of the photonic crystal lattice defect defining the optical cavity may be adjusted, if desired, to cause the optical mode of the cavity to be a polarised mode (e.g. linearly polarised). This may be achieved by breaking the symmetry of the optical cavity. For example, the lattice defect defining the optical cavity may be elongated in one dimension of the 2D photonic crystal plane. An example may be to remove one or more dielectric columns either side of the driven central (thinner) dielectric column, e.g. to elongate the cavity along a direction co-linear with the axis of a waveguide coupled to the cavity.

It has been found that the most efficient form of lattice array geometry for the photonic crystal structures of the various aspects and embodiments of the invention described herein, is the “triangular” array geometry, which appears in the examples illustrated herein. However, other geometries are permitted, such as a square lattice array geometry, or other arrangements including quasi-crystals.

The same procedure of epitaxial growth and etching steps may preferably be used to manufacture the silicon-based APD of FIG. 15 and the waveguide structure 82 on top of that. However, those structures or layers would preferably be grown in different epitaxy process chambers. These chambers are preferably linked via a system with a protected environment (e.g. high vacuum for molecular beam epitaxy (MBE), or inert gas for chemical vapour deposition (CVD)). This aims to keep the wafer clean and stops oxides forming etc. between process steps.

FIG. 18B illustrates a flow-diagram of steps in a sequence of process steps for manufacturing a photo-detector chip defining a single-photon detector, by a process of epitaxy. The method enables the manufacture of a photonic detector integrated chip. A first step 200 comprises epitaxially growing a substrate forming semiconductor layers (e.g. p-i-n semiconductor layers) of an avalanche photodiode (APD). This is followed by a second step 210 of epitaxially growing one or more layers directly upon the substrate, and subsequently (at a third step 220) forming (e.g. by etching) within the one or more layers an optical waveguide structure. The third step may include including forming a photonic crystal in the one or more layers in which the optical waveguide is formed within a photonic crystal. In a fourth step 230, an optical out-coupler is formed on the substrate (e.g. by etching, or deposition of material) so as to be optically coupled to the optical waveguide. The out-coupler is arranged to re-direct guided light from the optical waveguide structure into the substrate. The optical out-coupler may formed with a reflective surface disposed obliquely at an end of the optical waveguide, or as a diffraction grating structure (e.g. a Bragg mirror). In a subsequent step (240), electrical bias voltage electrodes are deposited upon the APD upon, or adjacent to, and in electrical communication with, the appropriate layers of the APD as necessary to drive the APD. For example, a bias voltage electrode may be placed in contact with a p-doped layer of a p-i-n semiconductor APD structure, and a bias voltage electrode may be placed in contact with an n-doped layer of the p-i-n semiconductor APD structure, to permit a bias voltage to be applied across the layers of the structure, including the intrinsic semiconductor layer) (see FIGS. 24 and 26).

The different layers are (84, 85, 83) of the silicon APD structure shown in figures herein may be structured and arranged according to many possible variations known in the art. The simplest would be a p-i-n. The APD structure in the figures herein has three layers, and comprises a p-i-n photodiode structure, in which the intrinsic region is engineered to provide the avalanche event. Other suitable examples can be found in the following review article:
Mohd Azlishah Othman, et al.: “Reviews on Avalanche Photodiode for Optical Communications Technology”; ARPN Journal of Engineering and Applied Sciences; Vol. 9; No. 1; January 2014 (ISSN 1819-6608)

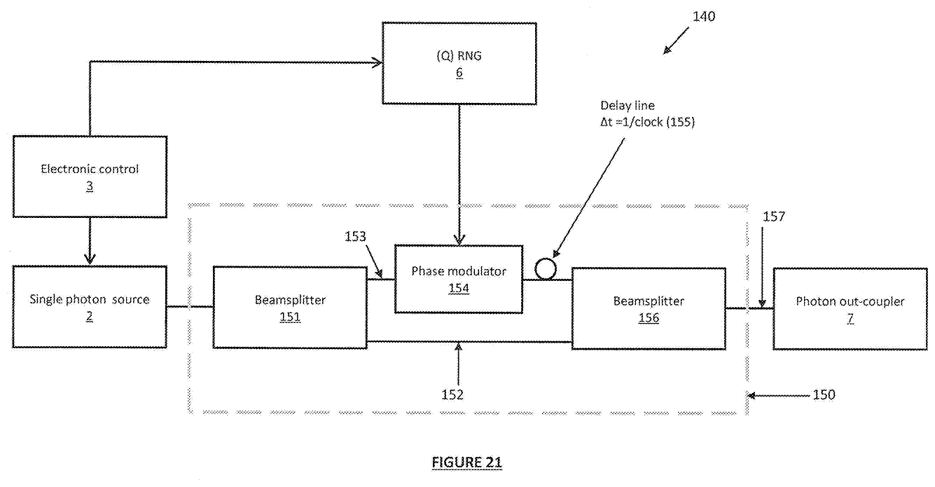

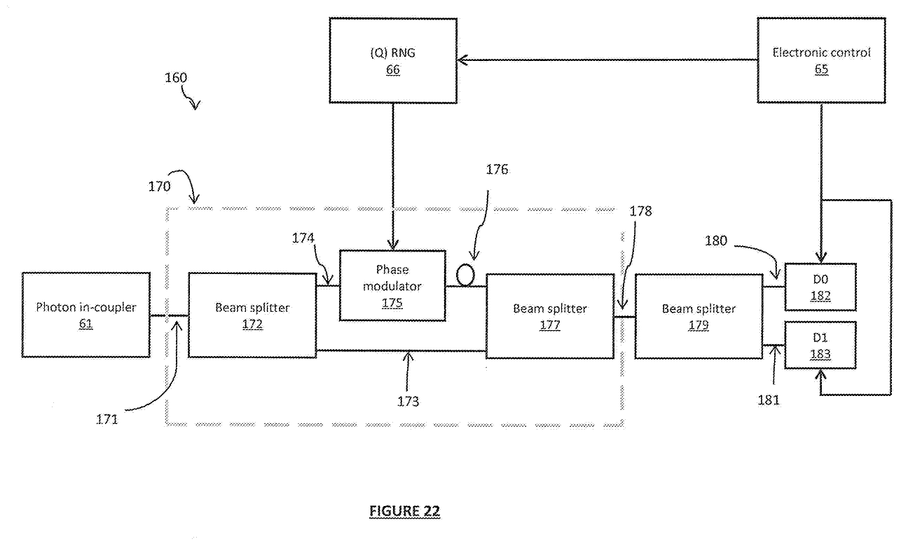

A quantum key distribution protocol, such as the BB84 protocol, may be implemented using the quantum key distribution transmitter of the present invention, or the quantum key distribution receiver of the present invention, or both in combination. For example, by a process of encoding information in the polarisation state, or phase state, of individual photons, the quantum key distribution transmitter/receiver apparatuses of FIGS. 1 and 11, or FIGS. 21 and 22, may implement a BB84 protocol as is well known in the art.

A single polarisation rotator, e.g. item 5 of FIG. 1, or item 62 of FIG. 11, is able to provide photons in any one of four separate polarisation states. For example, two orthogonal polarisation states (diagonal linear polarisation and anti-diagonal linear polarisation states) may be employed to create a “diagonal basis”, and another two orthogonal circular polarisation states (right-circular polarised and left-circular polarised states) may be used to create a second basis. These two bases provide the required two “bases” for use in BB84 protocols. As an alternative to diagonal/anti-diagonal polarisation states for a diagonal basis, one may use horizontal and vertical states of linear polarisation as a “rectilinear basis”, for use in conjunction with right-circular and left-circular states.

FIGS. 21, 22 and 23 show alternative embodiments of a quantum key distribution transmitter apparatus (FIG. 21), a corresponding quantum key distribution receiver apparatus (FIG. 22), and an alternative quantum key distribution receiver apparatus which may be used as an alternative to the receiver apparatus illustrated and described with reference to FIG. 11, above.

Notably, whereas the quantum key distribution transmitter/receiver apparatuses of FIGS. 1 to 20 and 23 employ a process of encoding information in the polarisation state of individual photons, the quantum key distribution transmitter/receiver apparatuses of FIGS. 21 and 22 employs a process of encoding information into the phase of individual photons, as follows.

Each of the arrangements illustrated in FIGS. 21, 22 and 23 employs one or more optical beam splitters (151, 156; 172, 177, 179). Each of these optical beam splitters is provided using a photonic crystal comprising a bifurcated (e.g. y-shaped) lattice defect in the crystal defining a bifurcated optical waveguide. The bifurcation structure is symmetrical such that incoming light is equally split/shared between the bifurcating arms of the beam splitter. In the transmitter/receiver apparatus illustrated in FIGS. 21 and 22, a respective phase modulator (154, 175) is provided using a photonic crystal comprising a linear lattice defect defining an optical waveguide within which is disposed a material which is responsive to an applied electrical field to change the value of its optical refractive index. Phase modulation is achieved in light propagating along the waveguide in question, through the index-adjustable material disposed within it, by applying an electrical field to the material to change its refractive index and, thereby change the speed of the light propagating through it. Upon exiting the waveguide, the phase of the light in question will be retarded by an amount proportional to the field-induced change in the refractive index, and the length of the waveguide over which the changed refractive index applied. Many suitable such materials possess a refractive index which is variable in response to an electric field applied across it, as will be readily apparent to the skilled person. The material is not birefringent so that the phase collected is the same for all polarisation modes of light entering a phase modulator. An example is the so-called ‘Dark Conglomerate’ phase of liquid crystal which is not birefringence, but which shows a refractive index which is variable according to an applied electrical field. Other materials are possible.

Referring to FIG. 21, the optical output of the single-photon source 2 is in optical communication with an input of a first optical beam splitter 151 which splits received optical radiation into two equal parts and to direct one of those two parts to an optical phase modulator 154, while simultaneously directing the other of those two parts to a continuing optical transmission line 152, such as a photonic crystal waveguide structure, which does not apply any phase modulation. The optical output of the phase modulator 154, and the continuing optical transmission line are each subsequently in optical communication with optical input parts of a second optical beam splitter 156 which is configured and arranged to receive the respective optical inputs and to combine them into one single optical output 157, by directing the received input optical signals into the convergence of a bifurcated photonic crystal optical waveguide structure, as described above. In particular, the second optical beam splitter 156 has the same structure as the first optical beam splitter 151, but is simply connected in reverse so as to receive input optical signals at its two bifurcated optical transmission lines for combining into one optical output transmission line 157. That optical output transmission line is in optical communication with the photon out-coupler 7, described above, for outputting light received by it.

The electronic control unit 3 is arranged to issue respective command control signals to both the single-photon source 2 and the quantum random number generator unit 6 in exactly the same manner as described above with reference to other embodiments employing these units. The quantum random number generator unit 6 is responsive to a command control signal to apply a randomly selected one of four different voltage control signals to the phase modulator unit 154. The phase modulator unit is responsive to the voltage control signal to apply an electric field across the aforementioned index-variable material disposed within the photonic crystal optical waveguide therein, so as to cause the index-variable material to change in value by a preselected one of four different amounts. Each change in refractive index value is selected to impose a corresponding one of four different phase modulations to light passing through the phase modulator. These four different phase modulation are preselected such that when the second beam splitter 156 ultimately recombines light received by it concurrently from the phase modulator 154 and the continuing optical transmission line 152, the optical phase of the resulting light output 157 from the beam splitter has an optical phase corresponding to a randomly selected one of four predetermined optical phase values. These four predetermined optical phase values define the four bases for use in a BB84 quantum key distribution protocol, such as would be readily apparent to the skilled person.

The optical beam splitter 172, the phase modulator 175, the continuing optical transmission line 173, and the further beam splitter 177 illustrated in the quantum key distribution receiver system of FIG. 22 are structured and arranged to operate in a manner described above with reference to the quantum key distribution transmitter system of FIG. 21. The quantum random number generator 66 of the quantum key distribution receiver system, is similarly responsive to a command control signal from the electronic control unit 65 of the receiver system, to output a randomly selected one of four predetermined phase control command signals to the phase modulator 175 which is responsive to apply a corresponding electrical field to index-variable material within the waveguide of the phase modulator 175. As described above, this results in the application of a randomly selected one of four predetermined phase modulations to light passing through the phase modulator. The result, as described above with reference to FIG. 21, is that recombines light output by the subsequent beam splitter 177 has a randomly selected one of four predetermined phases defining the bases of the BB84 protocol being used by the quantum key distribution transmitter system of FIG. 21. A terminal beam splitter unit 179 is arranged to receive the phase modulated output of the preceding beam splitter 177, and this beam splitter may have the same structure as the first beam splitter 172, so as to equally divide received optical radiation into two optical outputs (180, 181) arranged in optical communication with a respective one of two separate single-photon detectors (D0, D1; 182, 183). Each of these single-photon detectors is an avalanche photodiode (APD) subject to a bias voltage received from the electronic controller 65 to render the detectors responsive to receiving a single-photon, to generate an electrical detection signal. In differential phase shift QKD, single photons from successive photon pulses are caused to interfere with each other. In order to allow this to happen, a first photon which goes through one arm of the system has to be delayed to allow a second, following photon to catch up with the first. This delay is tuned according to the photon pulse frequency (the ‘clock’), this being the time between photon pulses (1/[clock frequency]) is shown in FIG. 21 as “At”, and is equally applicable to FIG. 22. This is the purpose of the delay line 155, of FIG. 21, and the delay line 176 of FIG. 22. The beam splitter 179 of FIG. 22 causes photons to travel down only one of its two output lines (180, 181), and this is determined by the phase of the photon in question. This means that a receiver can detect one of two different modulations by identifying which one of the two detectors (182, 183) detects a photon. The final beam splitter 179 achieves this by exploiting a two-photon interference effect well know to the person skilled in the art.

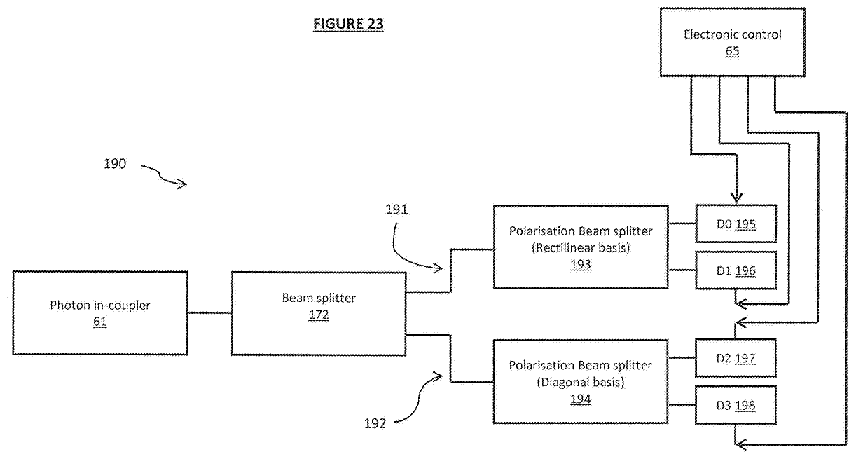

FIG. 23 shows another example of a quantum key distribution receiver apparatus comprising a photon in-coupler 61 for receiving incoming photons and directing received photons to an optical beam splitter 172, which may be of the same structure and function as the optical beam splitter 161 FIG. 21, or 172 of FIG. 22. The optical beam splitter 172 splits received light into two equal parts and outputs the result to optical output parts (191, 192) for input to a respective one of two separate polarisation beam splitter units (193, 194). A first one of the two polarisation beam splitter units 193 is arranged to direct received photons to one of two separate optical detectors (e.g. an avalanche photodiode detector) according to the state of linear polarisation of the received photon. In particular, if the received photon is horizontally polarised, it will be output to a first optical detector 195 (D0), whereas if the received photon is vertically polarised, it will be output to a second optical detector 196 (D1). Similarly, a second of the two polarisation beam splitter units 194 is arranged to direct received photons to one of two separate optical detectors (e.g. avalanche photodiode detector) according to the state of linear polarisation of the received photon. Thus, if the received photon is diagonally polarised, it will be output to a third optical detector 197 (D2), whereas if the received photon is anti-diagonal polarised, it will be output to a fourth optical detector 198 (D3). Accordingly, the detection of each one of four different linear polarisation states forming the four bases of a BB84 protocol, is enabled. The electronic control unit 64 is arranged, as described above in other embodiments, to apply a bias voltage to each of the avalanche photodiode detectors is to enable them to generate an electrical detection signal in response to receiving individual photons. The 50/50 beamsplitter 172 randomly directs photons to different directions, and this represents the QKD receiver (often referred to as ‘Bob’) random basis choices for measurement at the QKD receiver, e.g. according to a BB84 protocol.

An optical in-coupler and/or an optical out-coupler employed in preferred embodiments of the invention, may comprise a sequence of in-plane perturbations in a dielectric material disposed in-plane with the transmission axis of an optical waveguide, for receiving/inputting photons from/into or towards the optical waveguide. The optical in-coupler or out-coupler may incorporate integrated grating structures comprising periodic perturbations in the dielectric material of the coupler with a period that matches the optical mode of the optical waveguide it serves.

The dielectric perturbations within the coupler may be arcuate and concentric each with a radius of curvature converging within or upon the optical waveguide in question. The radius of curvature of successive arcuate perturbations may increase in succession such that neighbouring perturbations remain mutually parallel. In preferred embodiments, the concentric dielectric perturbations may be substantially semi-circular with a shared radius of curvature, which may converge upon the optical output end e.g. port, of the optical waveguide served by the optical in-/out-coupler. The periodic dielectric perturbations forming the in-/out-coupler may comprise consecutive ridges of optically transmissive higher refractive index material (e.g. SiO₂) separated by spacings containing lower refractive index material (e.g. air, or other lower-index optically transmissive material). The in-/out-coupler may comprise a planar slab or sheet of optically transmissive dielectric material (e.g. a glass, e.g. SiO₂) with the periodic dielectric perturbations each arranged to extend in length within the plane of the slab, and in depth transversely to the plane of the slab. The periodic perturbations may extend to/from an edge of the planar slab or sheet so as to be optically visible or present at that edge, rendering the in-/out-coupler able to attain an optical coupling immediately at that age. The radii of curvature of curved periodic perturbations may each converge upon the edge in question. There may be no more than two periodic perturbations in the dielectric material of the slab. These may comprise two concentric, curved grooves or slots or gaps empty of the dielectric material of the slab (but optionally containing lower index optically transparent material). The groups, slots, gaps or spacings may be each of the same constant width and may be of the same constant depth. In particular, such a structure may provide a Bragg mirror out-coupler 7, such as is described above with reference to FIGS. 7, 9, 10, 16 and 17 such a structure may provide a Bragg mirror in-coupler 61 as described with reference to FIG. 12.

In alternative arrangements, the periodic perturbations may each be linear and parallel perturbations, collectively forming an extended linear grating structure accessible from an optical input port structure (e.g. a waveguide end) located at the edge of the slab for receiving light into the slab (when an out-coupler) or for outputting light received into the slab via the grating structure e.g. when an in-coupler).

An optical out-coupler, in any embodiment employing an optical grating structure, serves to direct light which enters the slab at its edge, outwards from the optical grating in a direction transverse to the plane of the slab. Conversely, an optical in-coupler employing an optical grating structure, serves to receive light into the grating of the slab in a direction transverse to the slab, and to re-direct the received light in a direction along the plane of the slab to the edge of the slab for onward transmission (e.g. into a waveguide coupled to the slab edge). This general function of in-/out-coupler is employing optical gratings is as would be readily apparent to the skilled person.

The examples and embodiments described above, are provided to illustrate examples of the invention and are not intended to be limiting. As such, modifications, variants and equivalents to the examples and/or components therein, such as would be readily apparent to the skilled person, are encompassed by the scope of the invention, such as is defined e.g. by the claims.

1. A single-photon light source comprising:
a photonic crystal structure the lattice of which extends in at least two dimensions and includes a crystal defect defining an optical waveguide for guiding optical radiation emitted within the photonic crystal;
an electric field generator operable to apply an electric field to the photonic crystal; and
a light emitter selected from: a quantum dot; a quantum well; a light-emitting diode (LED), within the photonic crystal for responding to said electric field to acquire an excited state and by decaying from the excited state thereby emitting optical radiation into the photonic crystal for guiding by the optical waveguide.

2. A single-photon light source according to claim 1 in which the photonic crystal lattice includes a crystal defect defining an optical cavity which is optically coupled to the optical waveguide, and the light emitter is disposed within the optical cavity.

3. (canceled)

4. (canceled)

5. (canceled)

6. (canceled)

7. A single-photon light source according to claim 1 in which the photonic crystal is formed from one or more group III-V semiconductor materials and is formed upon a group IV semiconductor material.

8. A single-photon light source according to claim 1 in which the photonic crystal comprises a layered structure having three distinct layers of semiconductor material forming a p-i-n semiconductor switch arrangement.

9. A single-photon light source according to claim 1 in which said light emitter is within the intrinsic semiconductor material of the layered structure.

10. (canceled)

11. A single-photon light source according to claim 1 including a polarisation rotator arranged to adjustably change the state of polarisation of a photon generated by the light emitter.

12. A single-photon light source according to claim 1 in a quantum key distribution (QKD) transmitter system.

13. A waveplate comprising:
a photonic crystal structure the lattice of which extends in at least two dimensions and includes a crystal defect defining an optical waveguide for guiding optical radiation within the photonic crystal;
an electric field generator operable to apply an electric field to the photonic crystal; and
a field-induced birefringence material disposed within the crystal defect for reversibly responding to said electric field to acquire an optical birefringence thereby to impose a phase shift upon optical radiation guided by the optical waveguide.

14. (canceled)

15. A waveplate according to claim 8 in which the photonic crystal is formed from one or more group III-V semiconductor materials and is formed upon a group IV semiconductor material.

16. A waveplate according to claim 8 wherein the electric field generator is arranged to apply an electrical field to said field-induced birefringence material to adjustably change the state of polarisation of a photon within the crystal defect.

17. A method for manufacturing a photonic crystal integrated chip comprising:
epitaxially growing a first substrate comprising a group IV single crystal semiconductor material;
epitaxially growing a second substrate directly upon the first substrate, in which the second substrate comprises a group III-V single crystal semiconductor material; and
etching the second substrate to form a 2-dimensional photonic crystal structure.

18. A method according to claim 11 in which the second substrate is grown as a layered structure by growing a first sub-layer of n-doped semiconductor material directly upon the surface of the first substrate, and by growing an un-doped second sub-layer of intrinsic semiconductor material upon the surface of the first sub-layer, and by growing a third sub-layer of p-doped semiconductor material directly upon the surface of the completed second sub-layer.

19. A method according to claim 18 including growing of at least one light emitter selected from: a quantum dot; a quantum well; an LED, upon the exposed surface of the intrinsic semiconductor material, and subsequently growing further said intrinsic semiconductor material thereby to bury/embed/encase light emitter(s) within the intrinsic semiconductor material to complete the formation of the second sub-layer.

20. (canceled)

21. (canceled)

22. (canceled)

23. A photonic crystal integrated chip comprising a two-dimensional photonic crystal structure grown upon a substrate, wherein the photonic crystal structure comprises a group III-V single crystal semiconductor material and the substrate comprises a group IV single crystal semiconductor material thereby collectively defining an integrated photonic chip.

24. A photonic crystal integrated chip according to claim 23 in which the second substrate is a layered structure comprising a first sub-layer of n-doped semiconductor material grown directly upon the surface of the first substrate, and an un-doped second sub-layer of intrinsic semiconductor material grown upon the surface of the first sub-layer, and a third sub-layer of p-doped semiconductor material grown directly upon the surface of the completed second sub-layer.

25. A photonic crystal integrated chip according to claim including at least one light emitter selected from: a quantum dot; a quantum well; an LED, buried/embedded/encased within the intrinsic semiconductor material.

26. (canceled)

27. (canceled)

28. A photo-detector integrated chip comprising an optical waveguide structure formed in one or more layers grown upon a substrate and an optical out-coupler coupled to an optical waveguide structure to re-direct guided light from the optical waveguide structure into the substrate, wherein the substrate comprises semiconductor layers of an avalanche photodiode, thereby collectively defining an integrated photodetector chip.

29. A photodetector integrated chip according to claim 28 in which the avalanche photodiode structure is integrated with the optical waveguide and is optically coupled thereto via a planar reflective surface defining an optical out-coupler arranged to direct light in a direction transverse to the plane of the avalanche photodiode structure and towards it.

30. (canceled)

31. (canceled)

32. A photodetector integrated chip according to claim 28 in a quantum key distribution receiver photonic chip within which the photo-detector integrated chip is arranged to detect photons conveying a cryptographic key.

33. A method for manufacturing a photodetector integrated chip comprising:
epitaxially growing a substrate forming semiconductor layers of an avalanche photodiode;
epitaxially growing one or more layers directly upon the substrate;
forming within the one or more layers an optical waveguide structure and forming an optical out-coupler on the substrate optically coupled to the optical waveguide to re-direct guided light from the optical waveguide structure into the substrate.

34. (canceled)

35. (canceled)

36. (canceled)

37. A quantum key distribution transmitter apparatus for transmitting single photons conveying a quantum cryptographic key comprising a photonic crystal integrated chip according to claim 23.

38. A quantum key distribution receiver apparatus for receiving single photons conveying a quantum cryptographic key, comprising a photonic crystal integrated chip according to claim 23.
